(19) United States
(12) Patent Application Publication
(10) Pub. No.: US 2013/0141857 A1
(43) Pub. Date: Jun. 6, 2013

(54) MOBILE TERMINAL APPARATUS

(71) Applicant: Tatsuya SANO, Tokyo (JP)

(72) Inventor: Tatsuya SANO, Tokyo (JP)

(73) Assignee: SONY MOBILE COMMUNICATIONS JAPAN, INC., Tokyo (JP)

(21) Appl. No.: 13/597,736

(22) Filed: Aug. 29, 2012

Related U.S. Application Data
(60) Provisional application No. 61/554,106, filed on Nov. 1, 2011.

(51) Int. Cl. H04M 1/02; G06F 1/16

(52) U.S. Cl. CPC H04M 1/021; G06F 1/1615
USPC 361/679.27; 312/309

(57) ABSTRACT

A terminal apparatus that includes a first case, a second case, and a complex hinge module that has a slide hinge and a rotational hinge, to shift each of the first case and the second case between a closed state and an opened state. The slide hinge further includes a movable plate, a support plate that slidably supports the movable plate and is secured to the second case, and an elastic member configured to move the second case back toward the first case. The rotational hinge includes a fixed part secured to the first case, a rotational part which is rotatable on an axis common to the fixed part and the rotational part, and a link mechanism that connects the rotational part with the movable plate and has an extruding part to move the second case.

### CROSS REFERENCE TO RELATED APPLICATIONS

This application is related to and claims priority under 35 U.S.C. §119(e) to Provisional Application Ser. No. 61/554,106, filed Nov. 1, 2011, the contents of which are hereby incorporated herein by reference.

### BACKGROUND

1. Field

The present specification relates to a mobile terminal that performs a complex hinge operation in which the slide operation and rotational operation of a second case with respect to a first case are combined together.

2. Description of the Related Art

Mobile terminals typified by mobile phone terminals have come into widespread use in these days, and improvement of their portability, display visibility, and convenience is being pursued.

Known types of mobile terminals include a straight type in which a single case is used, a clamshell type in which a first case and a second case are mutually linked by means of a hinge to enlarge a display screen, and a slide type.

Recent mobile terminals called smart phones use a touch screen formed by overlaying a touch area on a display screen to eliminate a hardware numeric keypad, enabling the surface of the case to be substantially entirely used as the display screen.

In response to this trend, new types of mobile terminals are being studied to further enlarge the display screen size without the sacrifice of portability. Each of these new types of mobile terminals uses a first case and a second case, each of which has a display screen on its substantially entire surface. With the two cases closed (that is, in a closed posture), the second case, which is the upper case, is overlaid on the display screen of the first case, which is the lower case, with the display screen of the second case facing up. To place the two cases in an open state (that is, in a open posture), the second case is slid in parallel to the first case and the two cases are placed side by side so that the surfaces of display screens of the two cases are made to be flush with each other.

In the above structure, the projected area of the two cases in the closed state is equal to the area of one case when viewed from above. Although the thickness of the mobile terminal is slightly increased, the mobile terminal can have the same portability as conventional mobile terminals. In the open state, the two cases are placed side by side and the surfaces of the display screens of the two cases become flush with each other, enabling the two display screens to be used as if they were a large screen device with a double size.

To achieve the above open and close operations, a mechanism for linking the two cases needs a hinge that enables a complex operation in which a slide operation and a rotational operation are combined together.

As for a conventional slide operation, a slide hinge module that uses an elastic spring to support a slide operation performed by a user for a case with the elastic force of the elastic spring is proposed (see PTL 1). This module relates to a mobile telephone terminal that is slidably opened and closed by sliding an upper case having a display part, with respect to a lower case on which a keyboard is placed. The slide hinge module, which links the lower case and upper case together, is formed with a fixed plate and a movable plate slidably linked to the fixed plate with an elastic spring provided between the two plates. The elastic spring provides an elastic force so that, when the movable plate slides with respect to the fixed plate, the movable plate can be semiautomatically operated. More specifically, during the sliding of the movable plate, the movable plate is slid by an external force generated by the user until a dead point is reached. When the movable plate moves beyond the dead point, however, it automatically moves toward an end of the opposite side with the dead point taken as a boundary, due to the elastic force of the elastic spring. If the external force is removed before the movable plate reaches the dead point, the movable plate automatically moves back to the original end. Accordingly, the mobile terminal shifts to one of the stable states, open state and closed state.

As for a rotational operation, a rotational hinge formed with a movable cam, a fixed cam, and an invertible cam, which are attached to the same shaft, is proposed for clamshell-type mobile terminals (see PTL 2). The rotational hinge, in which the movable cam, fixed cam, and invertible cam are mutually disposed at predetermined rotational angles, has a lock mechanism that locks the rotation of the movable cam through the fixed cam. When a knob provided for the lock mechanism is rotated by the user, the lock mechanism is released and a spring force causes the movable cam to rotate so as to follow the invertible cam. In this structure, the mobile terminal then automatically shifts from the closed state to the open state by being triggered by an actuation operation performed by the user. In addition, when the clamshell-type mobile terminal is in the closed state, the upper case has no backlash for the lower case.

PTL 3 proposes a hinge through which a mobile information terminal having a first case on which a keyboard is placed and a second case on which an output screen is exposed performs a complex operation in which the slide operation and rotational operation of the two cases are combined together. A structure in which the first case includes a touch panel type of display device that doubles as an input device and the second case also has a display screen is also disclosed.

### CITATION LIST

### Patent Literature

[PTL 1] Japanese Unexamined Patent Application Publication No. 2010-279015
[PTL 2] Japanese Unexamined Patent Application Publication No. 2003-214423
[PTL 3] Japanese Unexamined Patent Application Publication No. 2009-059102

When a mobile terminal has display devices on both the upper case and the lower case to double the display screen size, however, the following problem arises.

Usually, a case has edge areas around the display screen of the display device. If two cases are placed side by side and the surfaces of the two display screens are made to be flush with each other, therefore, a strip-shaped space area is formed at the center of the large screen. To use the display screens of the two display devices as if the display screens were the large display screen of a single display device, this space area is preferably made to be small as much as possible. Since device manufacturing technology has been improved in recent years, it has been possible to reduce the edges around the display screen of the display device to extremely small widths.

However, the problem that rotational operation was impaired occurred during a shift to a rotational operation after a slide operation had been completed while a mobile terminal was being shifted from the closed state to the open state. Specifically, the lower edge of the back end of the upper case was brought into contact with the upper edge of the front end of the lower case. This problem can be solved by rounding these edges. If the edges are rounded, however, the two display screens cannot be brought close together.

This situation made the inventor in this application aware of the need to carry out a rotational operation smoothly without being impaired in a mobile terminal that performs a complex hinge operation in which the slide operation and rotational operation of a second case with respect to a first case are combined together.

### BRIEF SUMMARY

According to an embodiment, a terminal apparatus includes a first case, a second case, and a complex hinge module that has a slide hinge and a rotational hinge, to shift each of the first case and the second case between a closed state and an opened state. The slide hinge further includes a movable plate, a support plate that slidably supports the movable plate and is secured to the second case, and an elastic member configured to move the second case back toward the first case. The rotational hinge includes a fixed part secured to the first case, a rotational part which is rotatable on an axis common to the fixed part and the rotational part, and a link mechanism that connects the rotational part with the movable plate and has an extruding part to move the second case.

According to the embodiment, the front surfaces become substantially flush with each other. The elastic member moves the second case, by means of an elastic force, back to a position corresponding to a prescribed amount of slide enough for the second case to reach the open state if the second case slides more than the prescribed amount of slide. The extruding part extrudes the support plate against the elastic force of the elastic member due to the rotation of the rotational hinge during the rotation. When the second case slides beyond the prescribed amount of slide, the extruding part extrudes the support plate against the elastic force of the elastic member so that the back end of the second case bypasses the front end of the first case. The extruding part also discontinues the extrusion after the back end of the second case has bypassed the front end of the first case.

The structure and effect described above enable the rotational operation of the second case with respect to the first case to be smoothly carried out without being impaired.

More specifically, the extruding part is formed as a substantially triangular end, on the movable plate side, of an arm member constituting one link of the link mechanism, and the support plate has a projection with which the end of the arm member is brought into contact at the position corresponding to the prescribed amount of slide.

With the mobile terminal, the arm member may have a main body, and the substantially triangular end may be rotatably supported with respect to the main body within a prescribed rotational angle range.

The elastic member may be provided at a prescribed position on one of the support plate and the movable plate, and a projection that is brought into contact with the elastic member at the position corresponding to the prescribed amount of slide may be provided at a prescribed position on the other of the support plate and the movable plate.

The slide hinge may further have an elastic member that biases the movable plate in a first direction toward one end of the support plate when the movable plate is placed at the one end with an intermediate position in the slide range of the movable plate being taken as a boundary, and also biases the movable plate in a second direction toward the other end when the movable plate is placed at the other end.

The rotational hinge may further have an elastic member that provides a biased force with which the rotational part is rotated with respect to the fixed part and a locking member that locks the rotation of the rotational part at a predetermined angle with respect to the fixed part against the biased force in a state before the rotational hinge starts to rotate. The support plate may further have a rotation actuating member that unlocks the rotational hinge and actuates the rotation of the rotational part at a position while the movable plate shifts from a first stable state to a second stable state, the position being taken immediately before the movable plate reaches the second stable state.

Accordingly, it becomes possible to shift the mobile terminal from the closed state to the open state as a series of successive operations, including a slide operation biased by an elastic force and a rotational operation, in response to an actuation manipulation performed by the user.

### BRIEF DESCRIPTION OF THE DRAWINGS

FIGS. 1(a) to 1(c) illustrate the appearance of a mobile terminal according to an embodiment.

FIG. 2 illustrates a positional relationship among a first case, a second case, and a complex hinge module of the mobile terminal according to the embodiment.

FIG. 3 is an exploded perspective view of the complex hinge module illustrated in FIG. 2.

FIG. 4 is a perspective view of the complex hinge module in which the disassembled parts in FIG. 3 have been assembled, as viewed from the back of the complex hinge module.

FIG. 5 is a perspective view of major parts of the complex hinge module in which the disassembled parts in FIG. 3 have been assembled, as viewed from a side.

FIG. 6 illustrates a structure in which a movable part, arm members, and a rotational hinge in the embodiment are connected together.

FIG. 7 illustrates an example of the structure of an arm member 53 in the embodiment.

FIGS. 8(a) to 8(c) are schematic views generally illustrating the operation of an ordinary slide hinge.

FIGS. 9(a) to 9(c) are schematic views generally illustrating the operation of a slide hinge obtained by modifying the ordinary slide hinge.

FIGS. 10(a) and 10(b) are graphs representing changes in biased force corresponding to changes in the position of a movable plate in the Y-axis direction with respect to a support plate, in the non-modified slide hinge and modified slide hinge.

FIGS. 11(a) to 11(c) illustrates a prerequisite for the characteristic operation of the mobile terminal according to the embodiment.

FIGS. 12(a) to 12(c) illustrates the characteristic operation of the mobile terminal according to the embodiment.

FIGS. 13(a) to 13(i) illustrate more specific processes taken when the mobile terminal to which the embodiment has been applied shifts from a closed state to an open state.

FIG. 14 is an exploded perspective view of a complex hinge module in a variation of the embodiment.

FIG. 15 illustrates a structure in which the movable part, arm members, and rotational hinge in the variation in FIG. 14 are mutually connected.

FIGS. 16(a) and 16(b) are perspective views illustrating the arm member 53 alone in the variation in FIG. 14.

FIGS. 17(a) to 17(i) illustrate more specific processes taken when the mobile terminal to which the variation in FIG. 14 has been applied shifts from the closed state to the open state.

FIGS. 18(a) to 18(h) illustrate processes taken when the mobile terminal in FIG. 17 shifts from the open state to the closed state.

FIGS. 19(a) and 19(b) illustrate a structure in which a movable part, arm members, and a rotational hinge in a second embodiment are mutually connected.

FIG. 20 illustrates a structure in the second embodiment in which the arm member to which an unlocking member is attached is linked to the rotational hinge.

FIG. 21 a perspective view illustrating the appearance of the rotational hinge in the second embodiment.

FIG. 22 is an exploded perspective view of the parts constituting the rotational hinge in FIG. 21.

FIGS. 23(a) to 23(f) are six-plane views illustrating the appearance of the sliding cam of the rotational hinge.

FIGS. 24(a) to 24(f) are six-plane views illustrating the appearance of the rotor of the rotational hinge.

FIGS. 25(a) to 25(f) are six-plane views illustrating the appearance of the rotational cam of the rotational hinge.

FIGS. 26(a) to 26(d) illustrate processes taken when a first stable state of the rotational hinge, which corresponds to a locked state, is shifted to a second stable state of the rotational hinge after the lock is released.

FIGS. 27(a) to 27(d) illustrate processes taken when the second stable state of the rotational hinge is shifted back to the first stable state corresponding to the original locked state.

FIG. 28 illustrates smooth linkage between the slide operation and the rotational operation when a mobile terminal according to the second embodiment shifts from the open state to the closed state.

### DETAILED DESCRIPTION

Embodiments will be described below in detail with reference to the drawings.

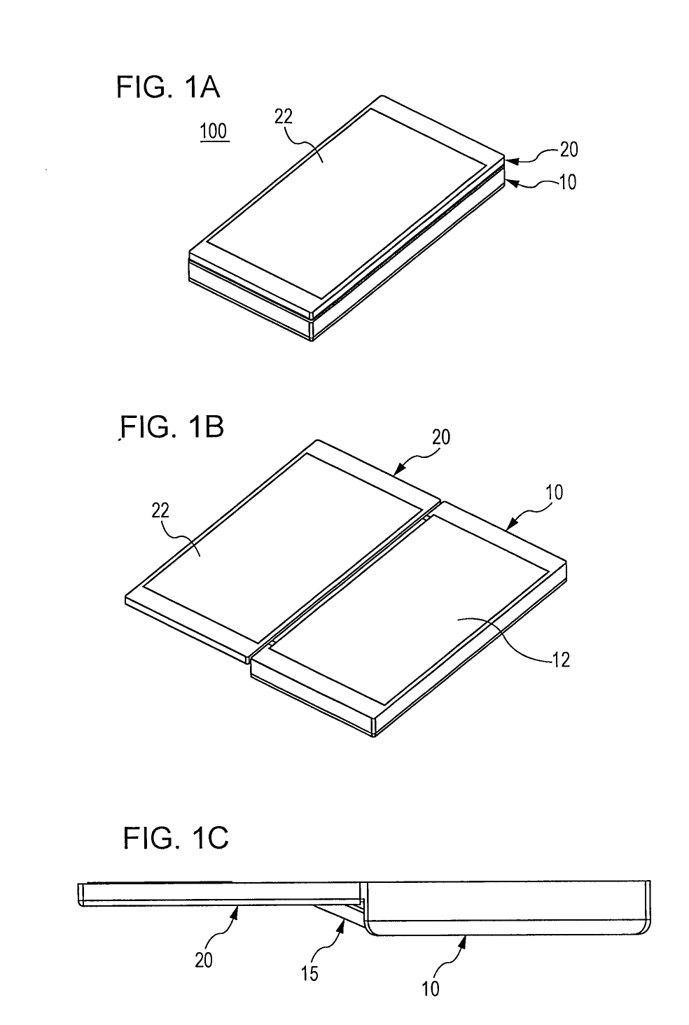

FIG. 1 illustrates the appearance of a mobile terminal 100 according to an embodiment. FIG. 1(a) is a perspective view of the mobile terminal placed in a closed state, FIG. 1(b) is a perspective view of the mobile terminal placed in an open state, and FIG. 1(c) is a side view of the mobile terminal placed in the open state.

The mobile terminal 100 has a first case 10, shaped like a substantially flat plate, which has a display screen 12 exposed on its front surface as a functional part, and also has a second case 20, shaped like a substantially flat plate, which has a display screen 22 exposed on its front surface as a functional part. In this example, the first case 10 is used as the lower case and the second case 20 is used as the upper case. When the mobile terminal 100 is in the closed state illustrated in FIG. 1(a), the rear surface of the second case 20 is overlaid on the front surface of the first case 10. That is, the second case 20 is placed on the first case 10 with its display screen 22 facing up so as to cover the display screen 12 of the first case 10. When the mobile terminal 100 in the open state illustrated in FIGS. 1(b) and 1(c), the first case 10 and second case 20 are placed side by side with the surfaces of their display screen 12 and display screen 22 being flush with each other. The first case 10 and second case 20 are linked together by a complex hinge module 15. The structure and operation of the complex hinge module 15 will be described below in detail.

At least one of the display screen 12 of the first case 10 and the display screen 22 of the second case 20 is preferably a touch screen that accepts touch manipulations made by the user. When the terminal is in the open state, the opposing edges of the display screen 12 and display screen 22 are brought close together as much as possible and the display screen 12 and display screen 22 thereby function as if they were a single display screen.

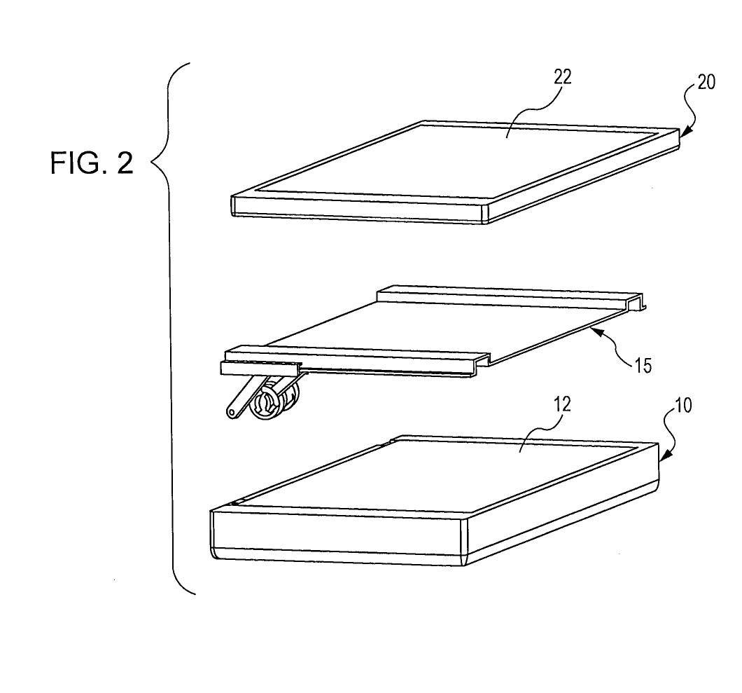

FIG. 2 illustrates a positional relationship among the first case 10, second case 20, and complex hinge module 15 of the mobile terminal 100. The mobile terminal 100 is structured by placing the complex hinge module 15 between the first case 10 and the second case 20 with their display screen 12 and display screen 22 facing up.

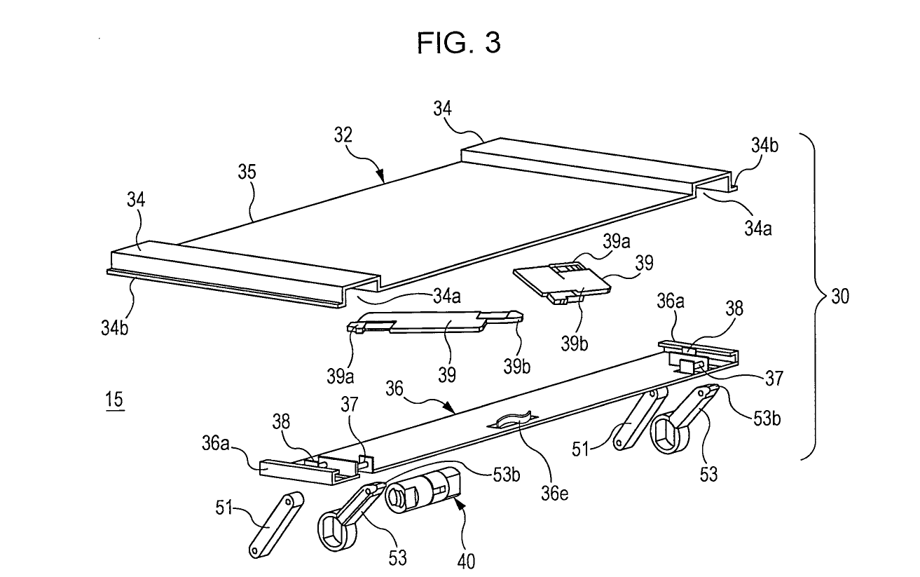

FIG. 3 is an exploded perspective view of the complex hinge module 15. The complex hinge module 15 includes a slide hinge 30, a rotational hinge 40, and arm members 51 and 53. One pair of the arm member 51 and arm member 53 is provided at each end of a movable plate 36, forming part of a link mechanism described later. Although, in this embodiment, only one rotational hinge 40 is used, which is disposed only at one end of the movable plate 36, two rotational hinges 40 may be used instead to dispose one rotational hinge 40 at each end of the movable plate 36.

The slide hinge 30 includes the movable plate 36, a support plate 32 secured to the rear surface of the second case 20, the support plate 32 linearly slidably supporting the movable plate 36, and a pair of spring members 39, which are elastic members. When the movable plate 36 is positioned at one end of the support plate 32 with an intermediate position in the slide range of the movable plate 36 being taken as a boundary, each spring member 39 biases the movable plate 36 in a first direction toward the one end. When the movable plate 36 is positioned at the other end, the spring member 39 biases the movable plate 36 in a second direction toward the other end.

More specifically, the support plate 32 is formed by bending opposing edges (shorter edges in this example) of a flat-plate-like member 35, which is rectangular and is made of a stiff material such as a metal or synthesized resin, to form slide guides 34 having a U-shaped cross section so as to form concave grooves 34a. However, the concave grooves 34a are not essential components.

The movable plate 36 is a member made of a stiff material that has almost the same width as the support plate 32 but is shorter than the support plate 32 in the slide direction. A hook 36a having an L-shaped cross section is formed at each end of the movable plate 36. When the hooks 36a at the two ends of the movable plate 36 slidably fit side edges 34b, each of which extends outwardly of the slide guide 34 of the support plate 32, it becomes possible for the movable plate 36 to slide in parallel to the support plate 32 and move fore and aft.

The pair of the spring members 39 is disposed between the support plate 32 and the movable plate 36. One end of each spring member 39 is secured at a prescribed position on the support plate 32, and the other end is secured at a prescribed position on the movable plate 36. To secure the movable plate 36, caulking or another fastening means can be used. The spring member 39 is secured at these positions is rotatable around an axis perpendicular to the plate.

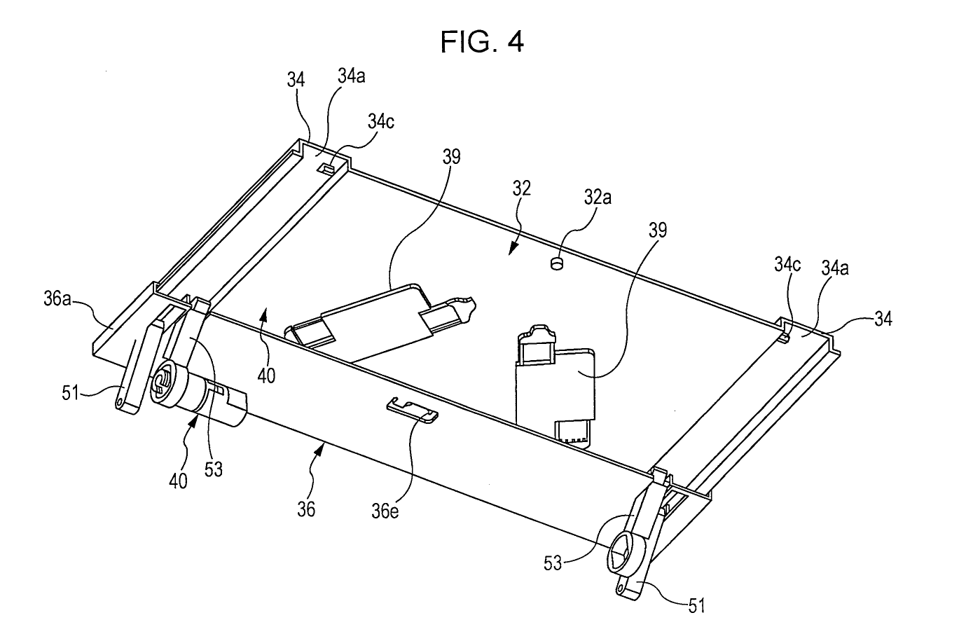

FIG. 4 is a perspective view of the complex hinge module 15 in which the disassembled parts in FIG. 3 have been assembled, as viewed from the back of the complex hinge module 15. This drawing illustrates an example in which the rotational hinge 40 is provided on only one side of the movable plate 36.

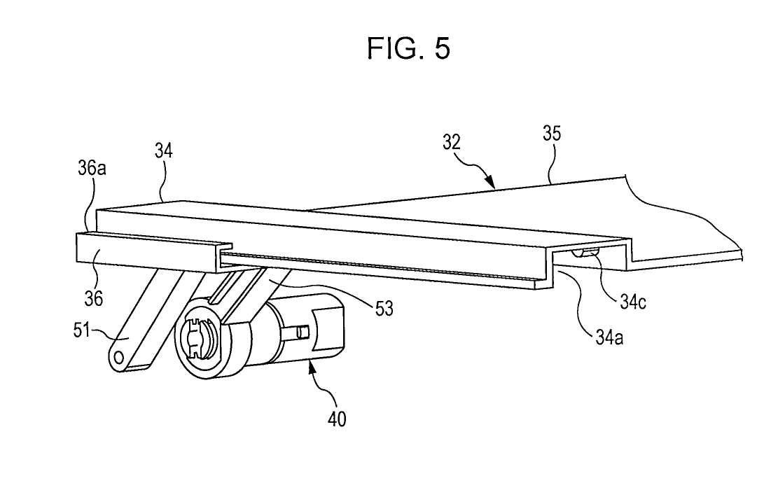

FIG. 5 is a perspective view of the major parts of the complex hinge module 15 in which the disassembled parts in FIG. 3 have been assembled, as viewed from a side. As well illustrated in this drawing, a projection 34c is provided at the bottom at one end of the concave grooves 34a of the slide guide 34 of the support plate 32. The function of the projection 34c will be described below. The rotational hinge 40 includes a fixed part 40a secured to the first case 10 and a rotational part 40b, which is rotatable on an axis common to the fixed part 40a and the rotational part 40b. The rotational part 40b is linked to the movable plate 36 through the link mechanism. The rotational hinge 40 includes an elastic member that provides a biased force with which the rotational part 40b is rotated with respect to the fixed part 40a and also includes a locking member that locks the rotation of the rotational part 40b at a predetermined angle with respect to the fixed part 40a against the biased force in a locked state (first stable state) before the rotational hinge starts to rotate.

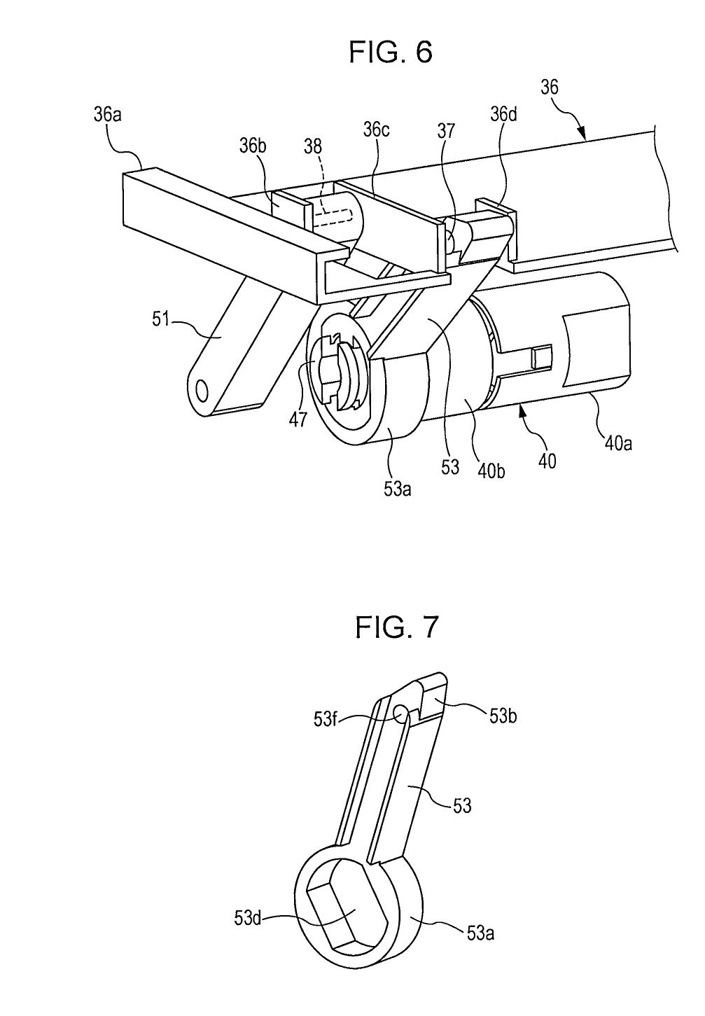

The structure in which the movable plate 36, the arm members 51 and 53, and the rotational hinge 40 are linked together will be described with reference to FIG. 6. One end of the arm member 51 is rotatably linked to the first case 10 and the other end is rotatably linked to the movable plate 36. In the example in the drawing, a support shaft 38 is provided, at a side of the movable plate 36, across shaft support members 36b and 36c provided so as to stand, the support shaft 38 extending along the longitudinal direction of the movable plate 36. The support shaft 38 passes through a through-hole formed at the upper end of the arm member 51.

One end of the arm member 53 is rotatably linked to the side of the movable plate 36. A support shaft 37 is provided, at the side of the movable plate 36, across the shaft support member 36c and a shaft support member 36d provided so as to stand, the support shaft 37 extending along the longitudinal direction of the movable plate 36. The support shaft 37 passes through a through-hole formed at the upper end of the arm member 53. For the sake of making the support shaft 37 visible, the upper end of the arm member 53 in the drawing is cut.

A ring-shaped member 53a provided for the arm member 53 on the side on which the rotational hinge 40 is not disposed is connected to the first case 10 so that the arm member 53 can rotate with the ring-shaped member 53a serving as a fulcrum.

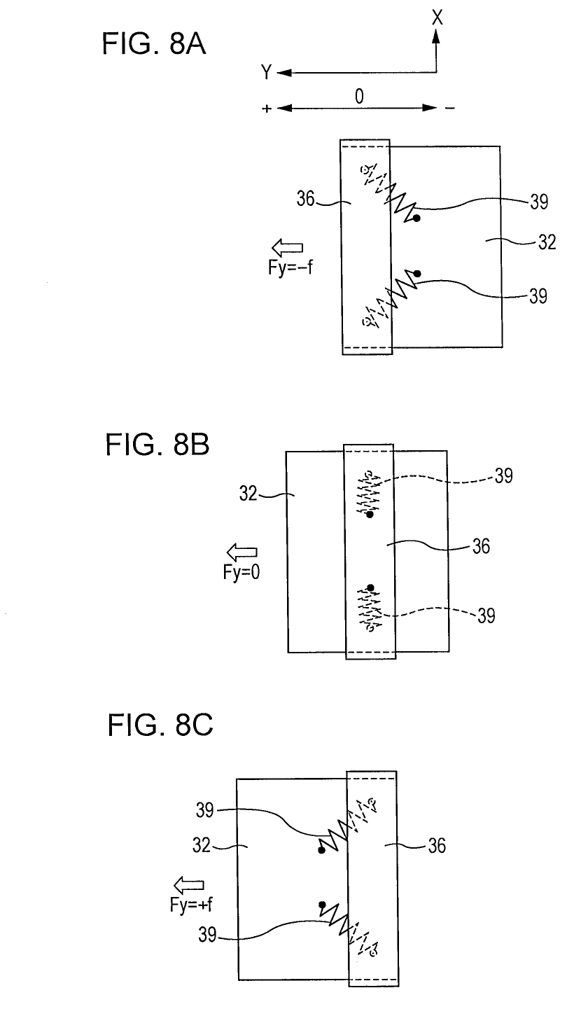

FIG. 7 illustrates an example of the structure of the arm member 53. The arm member 53 has the ring-shaped member 53a at its bottom. When an end, the cross section of which is not circular, of the rotational part 40b of the rotational hinge 40 is fitted into a through-hole 53d, the cross section of which is not circular, formed in the ring-shaped member 53a, the ring-shaped member 53a is linked to the rotational part 40b. Accordingly, the arm member 53 is linked to the rotational part 40b so as not to be rotatable. The arm member 53 has a through-hole 53f, the cross section of which is circular, and a top part 53b protruding in a substantially triangular shape at the top. The effect of the arm member 53 will be described later.

A four-node link mechanism is formed with the arm members 51 and 53, as illustrated in FIG. 6, the movable plate 36, and the first case 10. This link mechanism has a pair of first arm members 53 and a pair of second arm members 51, which are connected between the movable plate 36 and the first case 10, so as to enable the movable plate 36 to move substantially in parallel to the first case 10. The end of at least one of the pair of the first arm members 53 is connected to the first case 10 through the rotational hinge 40. This link mechanism enables the second case 20 to rotate with respect to the first case 10 within the rotational range of the rotational hinge 40 while the first case 10 and movable plate 36 (by extension, the support plate 32 and the second case 20) are kept parallel to each other. The opposing links of the four-node link mechanism do not necessarily have the same length. The parallel state between the first case 10 and movable plate 36 is sufficient if the parallel state is maintained in the first stable state (locked state) and second stable state of the rotational hinge 40.

When the second case 20 slides in parallel to the first case 10 from the closed state of the mobile terminal 100 illustrated in FIG. 1(a) (the first stable state of the slide hinge) and the second stable state of the slide hinge is reached, the rotational hinge 40 starts to rotate, after which the first case 10 automatically moves by rotation to a position at which the surface of the second case 20 becomes flush with the surface of the first case 10 as illustrated in FIGS. 1(b) and 1(c).

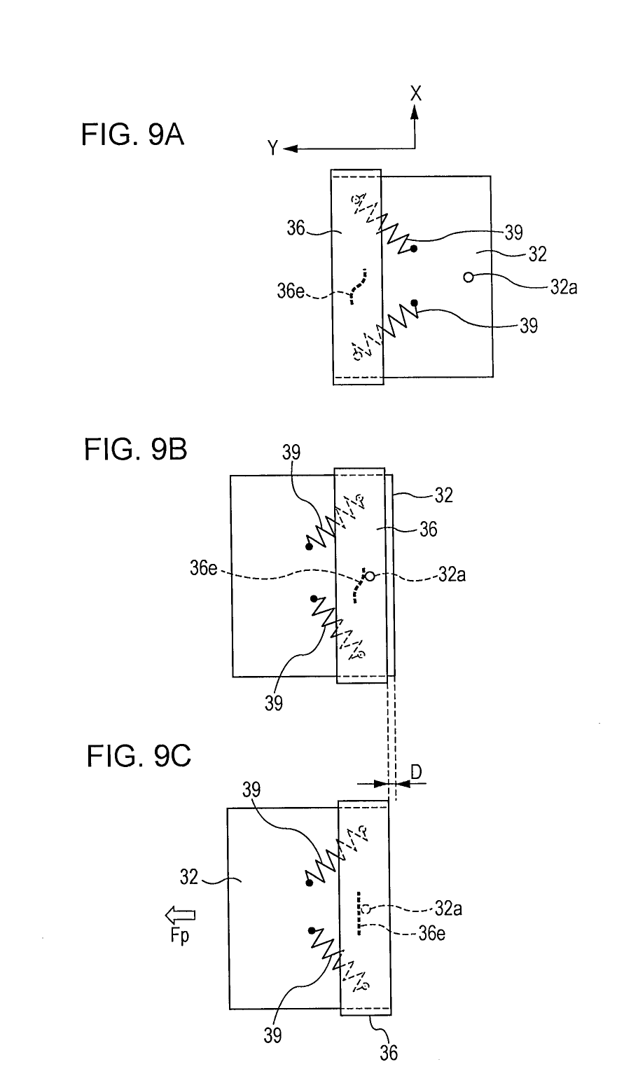

FIG. 8 gives schematic views generally illustrating the operation of an ordinary slide hinge 30. FIGS. 8(a) to 8(b) illustrate three typical positional relationships among the support plate 32, movable plate 36, and spring members 39 of the slide hinge 30. The spring member 39 is used as a compression spring, which generates a repulsive force when compressed. The operation of the slide hinge relative to the position of the movable plate 36 will be described below.

FIG. 8(a) illustrates a state in which the movable plate 36 is positioned at one end of its movable range. This state is the first stable state of the slide hinge 30, in which this positional relationship is maintained unless an external force is exerted. Even in this state, the spring members 39 are compressed to a certain extent, so there are repulsive forces. The direction in which the movable plate 36 moves is defined as the Y-axis direction. The sum of Y-axis components of the repulsive forces of the two spring members 39 is a biased force Fy, in the Y-axis direction, applied to the movable plate 36. Fy in this state is a negative value, −f.

The operations of the movable plate 36 and support plate 32 are relative. In a practical application of the slide hinge 30, the movable plate 36 may move with respect to the stationary support plate 32; conversely, the support plate 32 may move with respect to the stationary movable plate 36.

When, in the state in FIG. 8(a), the support plate 32 starts to move with respect to the movable plate 36 toward the other end in the Y-axis direction (from right to left in the drawing), each spring member 39 is further compressed. The repulsive force of the spring member 39, which has been generated by this compression, is increased and maximized at a position at which the spring member 39 is most compressed (nearly at the central position of the support plate 32 in this example) as illustrated in FIG. 8(b). In this case, however, the repulsive force is directed in the X-axis direction perpendicular to the Y-axis direction, so the biased force Fy becomes 0. That is, this position is a dead point at which a force in the Y-axis direction is not exerted on the movable plate 36 at all; the dead point is an unstable point. When the movable plate 36 moves beyond this dead point, the spring member 39 gradually extends on the opposite side on the support plate 32 and the repulsive force is gradually decreased. The biased force Fy in the Y-axis direction is inverted and becomes a positive value, +f. The repulsive force continues until the opposite end of the support plate 32 is reached as illustrated in FIG. 8(c) is reached. This state is the second stable state of the slide hinge 30, in which this positional relationship is maintained unless an external force is exerted.

As described above, when the movable plate 36 is positioned at one end of the support plate 32 with an intermediate position in the slide range of the movable plate 36 being taken as a boundary, the spring members 39 incorporated in the slide hinge 30 bias the movable plate 36 in the first direction toward the one end. When the movable plate 36 is positioned at the other end, the spring members 39 bias the movable plate 36 in the second direction toward the other end.

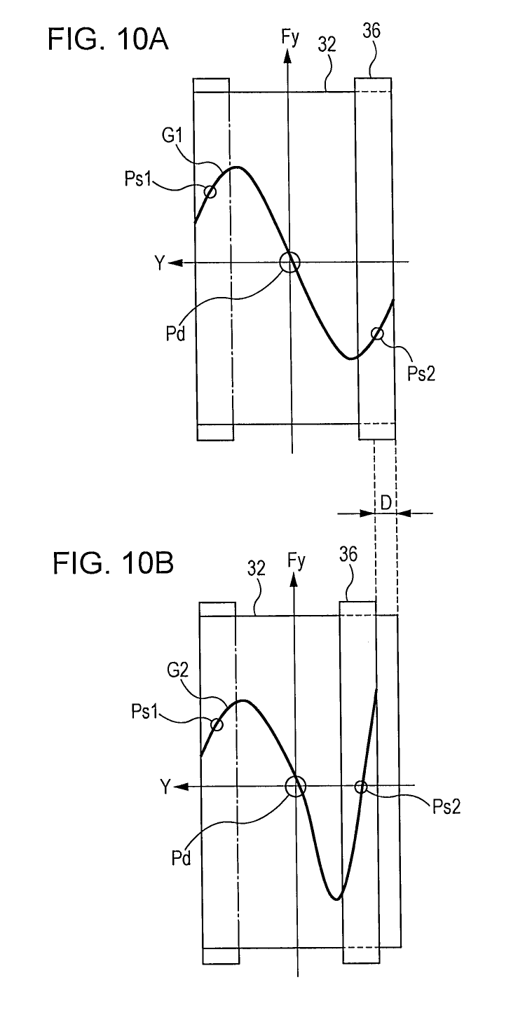

In this embodiment, the structure of the slide hinge 30 of this type is slightly modified. The operation of the modified slide hinge will be described with reference to FIG. 9. This modification involves the addition of an elastic member 36e placed at a prescribed position on the movable plate 36 and a projection 32a, which comes into contact with the elastic member 36e at a prescribed position on the rear surface of the support plate 32 (position corresponding to a prescribed amount of slide). The other elements are the same as in FIG. 8. Here, the elastic member 36e is assumed to be a spring member such as a leaf spring. However, the elastic member 36e is not limited to a spring member.

FIG. 9(a) corresponds to the first stable state, illustrated in FIG. 8(a), of the slide hinge 30. FIG. 9(b) illustrates a state that is reached when the support plate 32 moves from the state in FIG. 9(a) in the positive direction of the Y axis (to the left in the drawing) with respect to the movable plate 36, the projection 32a comes into contact with the elastic member 36e, and a balance is achieved between the biased force Fy of the spring members 39 in the positive direction of the Y axis and the elastic force of the elastic member 36e in the Y axis. With the modified slide hinge, therefore, the state in FIG. 9(b) is the second stable state. FIG. 9(c) illustrates a state that is reached when the support plate 32 placed in the state in FIG. 9(b) is further pushed in the Y-axis direction with an external manipulation force Fp, is thereby moved in the Y-axis direction against the elastic force of the elastic member 36e with respect to the movable plate 36, and reaches an end of the slidable range. When the external manipulation force Fp is removed, the slide hinge returns to the second stable state in FIG. 9(b).

The position of the support plate 32 illustrated in FIG. 9(b) in the Y axis direction is the position inward by a displacement D from the end, illustrated in FIG. 9(c), of the movable range of the support plate 32 in the Y-axis direction.

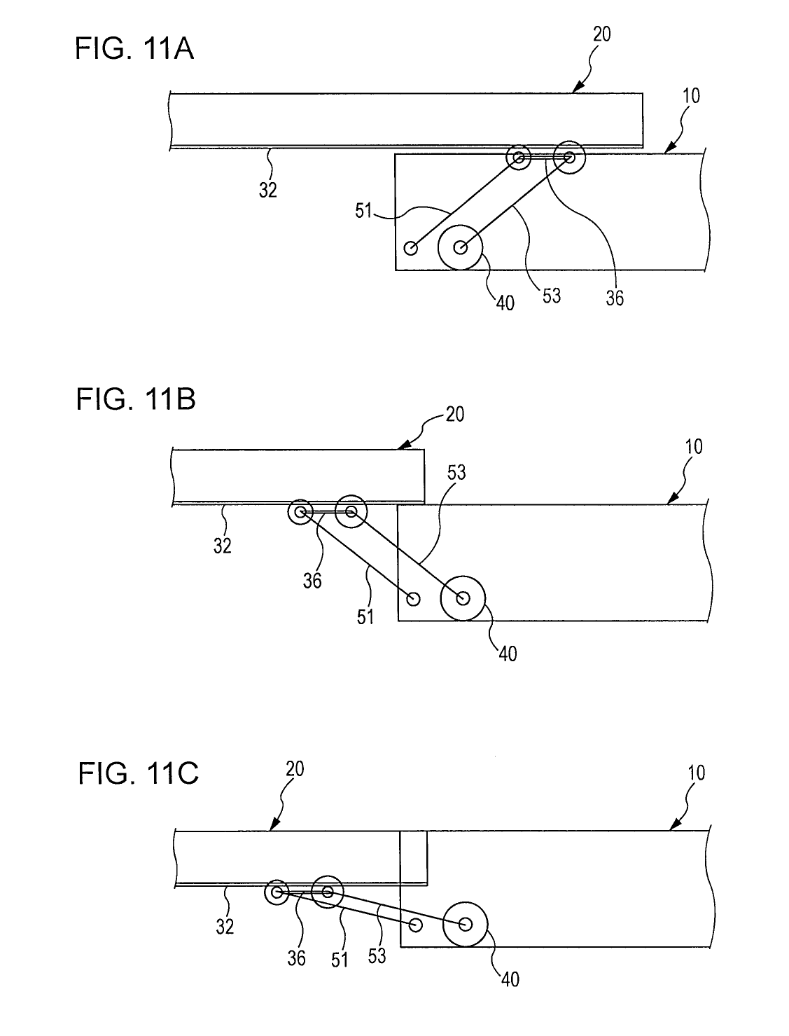

FIGS. 10(a) and 10(b) represent, as graphs G1 and G2, changes in biased force Fy corresponding to changes in the position of the movable plate 36 in the Y-axis direction with respect to the support plate 32, in the non-modified slide hinge 30 and modified slide hinge 30. In graph G1 in FIG. 10(a), both points Ps1 and Ps2 (stable points) in the first and second stables states are at the ends of the slidable range of the movable plate 36 with respect to the support plate 32. The central point Pd is the dead point. It is found that the sign of the biased force Fy is inverted with the dead point Pd taken as a boundary.

By contrast, in graph G2 in FIG. 10(b), point Ps2 in the second stable state is inward of the end of the slidable range. Point Ps2 in the second stable state in FIG. 10(b) is obtained as a result of the balance between the elastic force of the elastic member 36e and the biased force Fy of the spring members 39. Even if, in the second stable state, the movable plate 36 slightly is moved by an external force applied to the movable plate 36 in the Y-axis direction with respect to the support plate 32 as illustrated in FIG. 9(c), the slide hinge 30 returns to the second stable state (point Ps2) when the external force is removed.

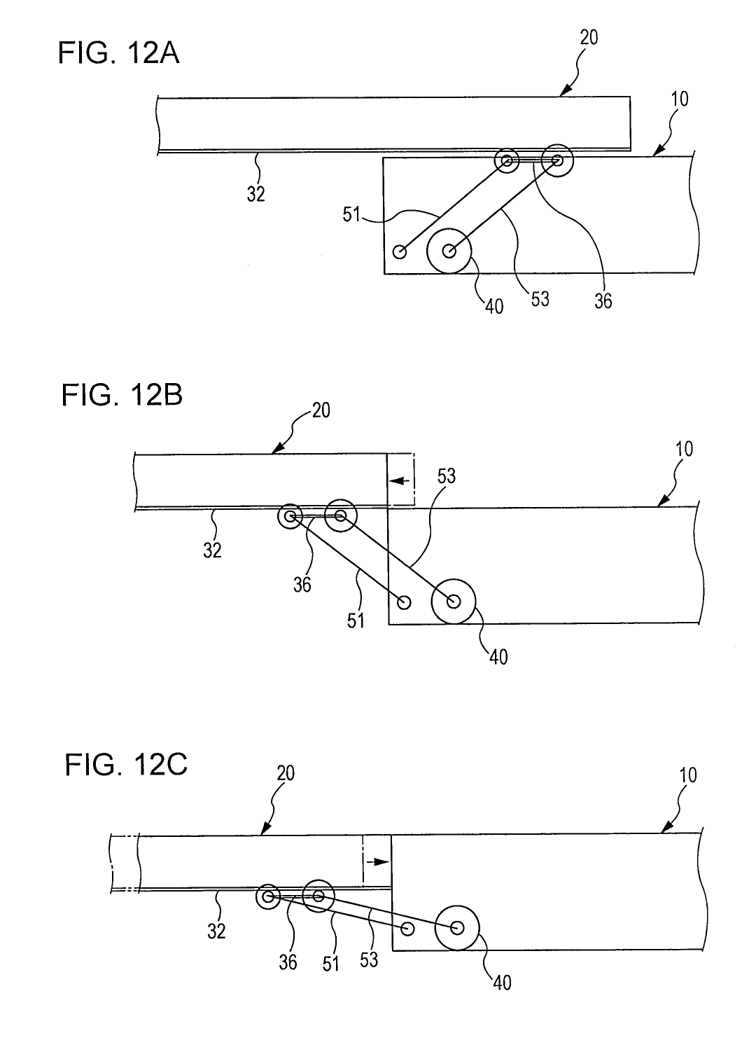

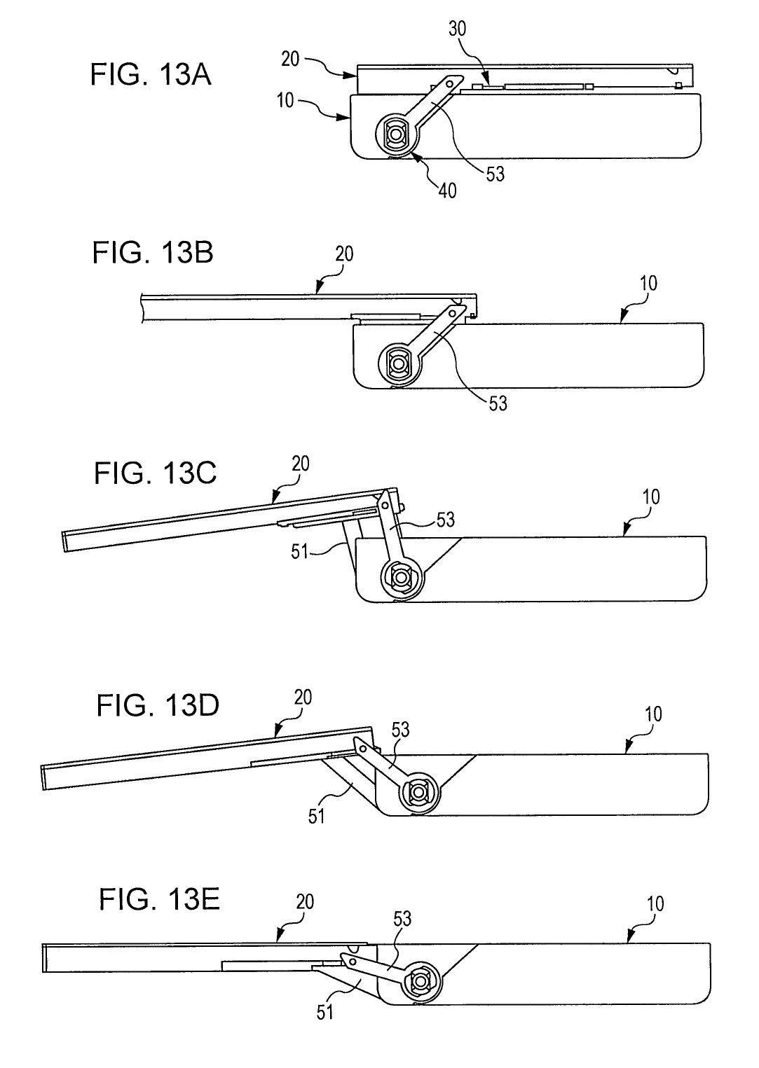

FIGS. 11 and 12 illustrate the characteristic operation of the mobile terminal according to the embodiment. FIG. 11 illustrates a problem caused in a case (FIG. 10(a)) in which neither the elastic member 36e nor the projection 32a is used. FIG. 12 illustrates an exemplary operation in this embodiment that solves the problem.

FIG. 11(a) illustrates a state in which the second case 20 has reached the end of the slidable range in a case in which neither the elastic member 36e nor the projection 32a is used. This position is equivalent to a rotation start point (first stable state) taken by the rotational hinge 40. At a rotation termination position (second stable state) set for the rotational hinge 40, this position is a position at which the open state, in which the second case 20 is placed adjacent to the first case 10 so that the surface of the second case 20 becomes substantially flush with the surface of the first case 10, is obtained. During the rotation of the rotational hinge 40 in a shift from the state in FIG. 11(a) to the state in FIG. 11(c) (that is, during the movement of the second case 20), however, the lower edge of the back end of the second case 20 comes into contact with the upper edge of the front end of the first case 10 as illustrated in FIG. 11(b). This impairs not only an expected rotation of the rotational hinge 40 but also an expected rotation of the second case 20 with respect to the first case 10 through the link mechanism.

In this embodiment, therefore, an extruding part is provided in the link mechanism, the extruding part extruding the support plate 32 (second case 20) due to the rotation of the rotational hinge 40 at an intermediate point in the rotation against the elastic force of the elastic member 36e, as illustrated in FIG. 12(b). Due to the effect of the extruding part, the second case 20 moves by the amount of slide exceeding a prescribed amount of slide equivalent to the displacement D described above. The extruding part is formed with the top part 53b protruding in a substantially triangular shape on the arm member forming one link of the link mechanism on the same as the movable plate 36. The support plate 32 has the projection 34c on an inner wall of the concave grooves 34a of the slide guide 34. The projection 34c is formed at a position at which the top part 53b of the arm member 53 comes into contact with the projection 34c when the prescribed amount of slide is made.

This extruding part (top part 53b) and the projection 34c cause the second case 20 to move so that the back end of the second case 20 bypasses the front end of the first case 10 during the rotational operation of the rotational hinge 40. As illustrated in FIG. 12(c), the link mechanism operates so as to cancel the extrusion caused by the extruding part after the back end of the second case 20 has bypassed the front end of the first case 10. As a result, the second case 20 is moved back toward the first case 10 due to the elastic force of the elastic member 36e and reaches the position at which the second case 20 placed adjacent to the first case 10.

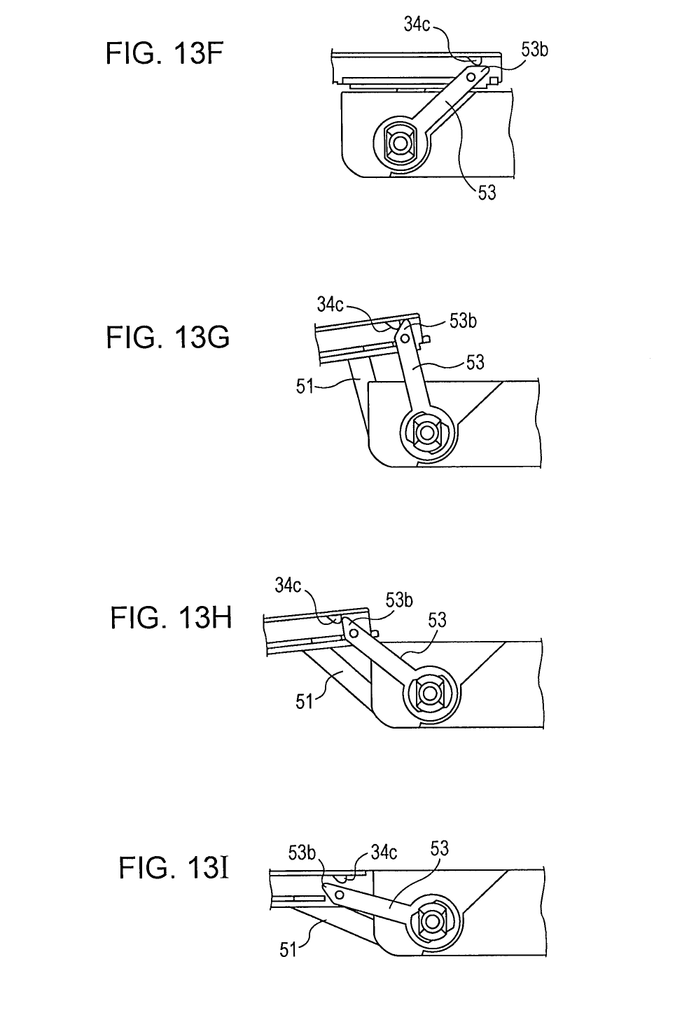

More specific processes taken when the mobile terminal to which the embodiment has been applied shifts from the closed state to the open state will be described with reference to FIG. 13. FIGS. 13(a) to 13(e) are general side views of the mobile terminal at stages in these sequential processes. FIGS. 13(f) to 13(i) are enlarged views of the major parts in FIGS. 13(b) to 13(e).

The second case 20 is slid forward (to the left in the drawing) from the closed state of the mobile terminal illustrated in FIG. 13(a) with respect to the first case 10 by a manipulation force exerted by the user. When moving beyond the dead point, the effect of the slide hinge causes the second case 20 to proceed to the second stable state of the slide hinge as illustrated in FIG. 13(b). At that time, the projection 34c of the support plate 32 is at a position immediately after the projection 34c has passed immediately above the top part 53b of the arm member 53. At this point, the rotational hinge 40 starts to rotate.

When the rotational hinge 40 is actuated by a predetermined trigger, the rotational hinge 40 starts to rotate and thereby the arm members 51 and 53 start to rotate. This trigger may be generated by a user's manipulation or an unlocking member operated by the movement of the slide hinge as in a second embodiment described later.

FIGS. 13(c) and 13(d) illustrate states at two points in time during the rotation of the rotational hinge 40. As illustrated in FIGS. 13(g) and 13(h) in which the major parts are enlarged, the top part 53b operable as the extruding part comes into contact with the back end of the projection 34c of the support plate 32 due to the rotation of the arm member 53 of the link mechanism. Accordingly, the support plate 32 (by extension, the second case 20) is temporarily slid forward at least by the predetermined amount of slide with respect to the movable plate 36, which is the above displacement D. As a result, the interference between the first case 10 and the second case 20 can be avoided.

When the rotational hinge 40 completes its rotation and the mobile terminal enters the open state, the surface of the second case 20 becomes substantially flush with the surface of the first case 10 as illustrated in FIG. 13(e). In this state, as seen from FIG. 13(i), in which the major parts are enlarged, the top part 53b has passed the front end of the projection 34c and can no longer maintain the state in which the top part 53b is in contact with the projection 34c. As a result, the second case 20 is moved back toward the first case 10 by the elastic force of the elastic member 36e and reaches a position at which the second case 20 is placed adjacent to the first case 10.

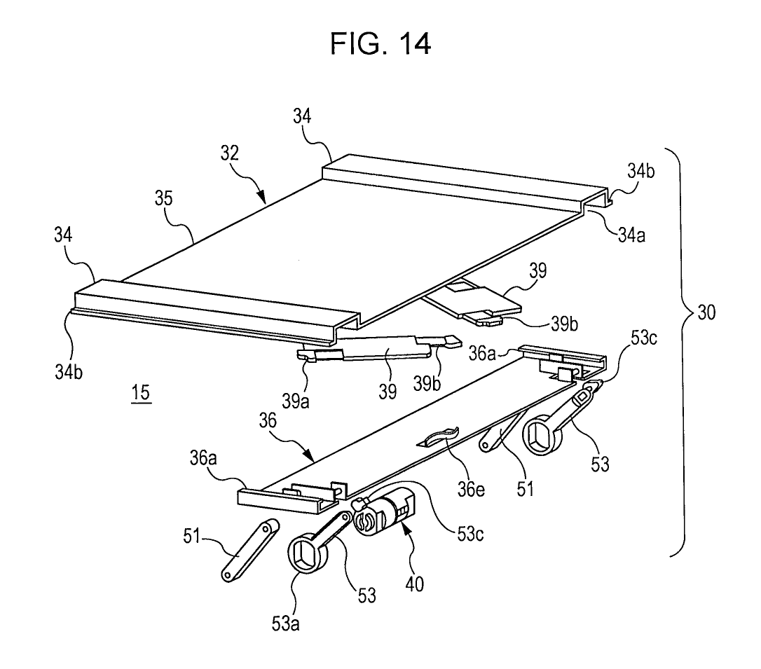

Next, a variation of the above embodiment will be described. FIG. 14 is an exploded perspective view of the complex hinge module 15 in this variation. In this drawing, the same elements as in the complex hinge module 15 in FIG. 3 are denoted by the same reference numerals and repeated descriptions will be omitted.

The extruding part described above has been formed, as part of the main body of each of a pair of the arm members 53 disposed at the two ends of the movable plate 36, at the end of the arm member 53. By contrast, in this variation, a top part 53c in a substantially triangular shape is provided at the end of a main part 53e of the arm member 53 as the extruding part separated from the main part 53e, as illustrated in FIG. 14. The top part 53c is rotatably supported within a prescribed rotational angle range with respect to the main part 53e of the arm member 53.

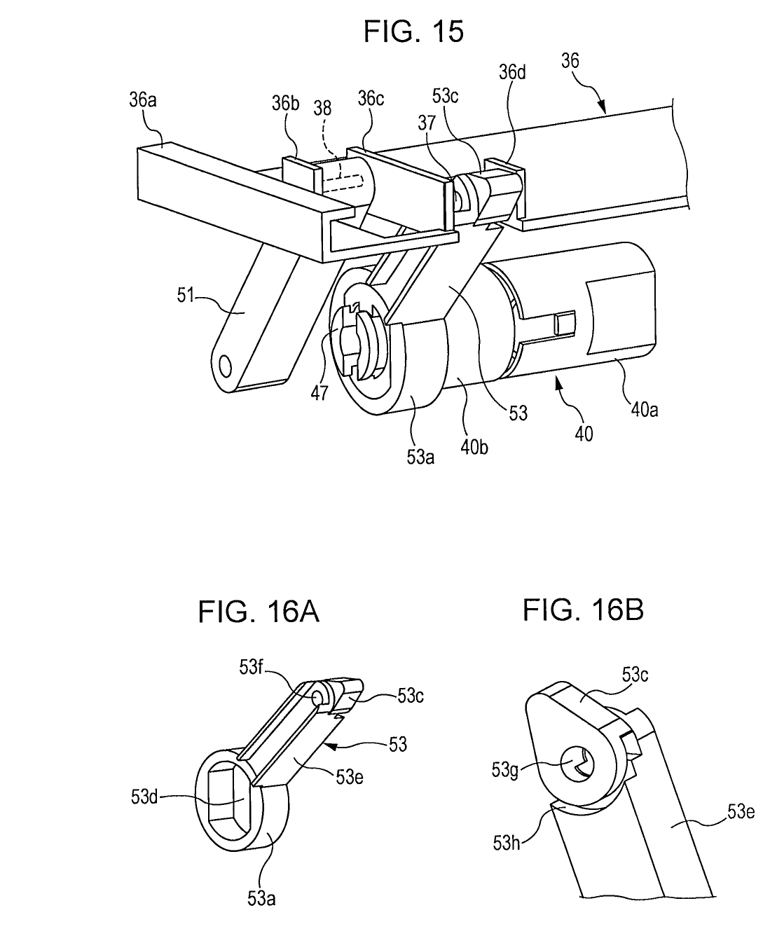

FIG. 15 illustrates a structure in which the movable part 36, arm members 51 and 53, and rotational hinge 40 in this variation are mutually connected. In this drawing, the same elements as in FIG. 6 are denoted by the same reference numerals and repeated descriptions will be omitted. As illustrated in the drawing, the end of the main part 53e of the arm member 53 is rotatably supported by the support shaft 37. In addition, the top part 53c is also rotatably supported around the support shaft 37 within the prescribed rotational angle range with respect to the main part 53e.

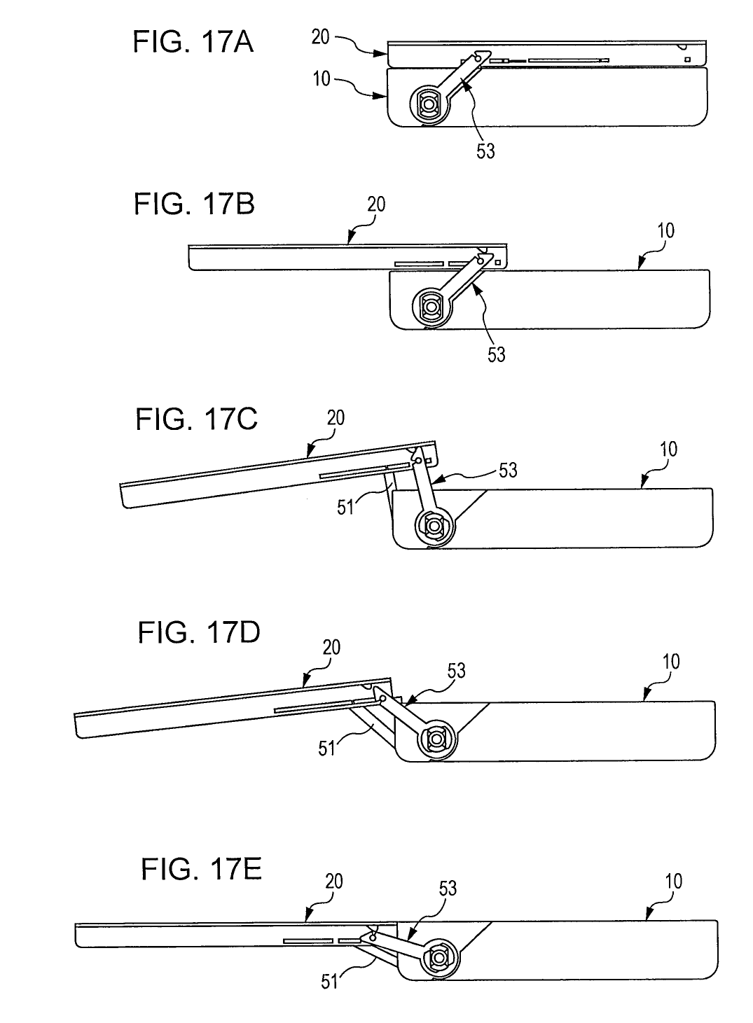

FIGS. 16(a) and 16(b) are perspective views illustrating the arm member 53 alone in the variation. A through-hole 53f having a circular cross section is formed at the end of the main part 53e of the arm member 53, the support shaft 37 passing through the through-hole 53f. A through-hole 53g having a circular cross section is also formed in the top part 53c, the support shaft 37 passing through the through-hole 53g. The top part 53c is rotatably supported above a cutout 53h formed at the end of the main part 53e with the through-hole 53f and through-hole 53g being aligned.

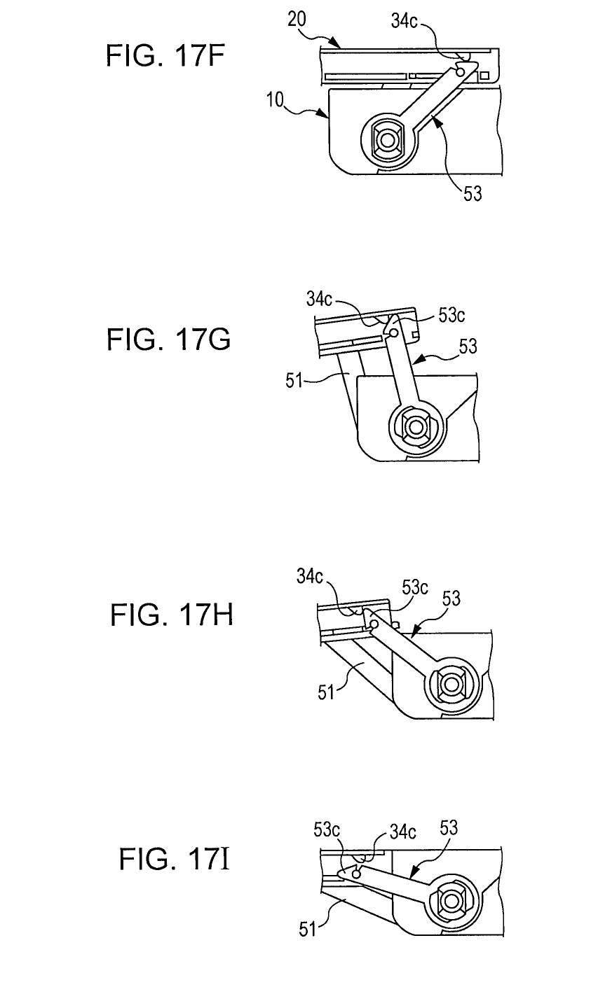

More specific processes taken when the mobile terminal to which this variation has been applied shifts from the closed state to the open state will be described with reference to FIG. 17. The same elements as in FIG. 13 are denoted by the same reference numerals and repeated descriptions will be omitted. FIGS. 17(a) to 17(i) are basically identical to the FIGS. 13(a) to 13(i), but there is a slight change in operation that is caused because the top part 53c operable as the extruding part, which has been an integral part of the arm member 53, was formed as the top part 53c, which is movable as a separate part. In the rotation processes of the second case 20 in FIGS. 17(a) to 17(d), as well illustrated in FIGS. 17(f) to 17(h), in which the major parts are enlarged, the movable 53c is inclined backward toward one limit of its movable range. The top part 53c in these rotation processes is practically the same as the top part 53b.

As well seen from FIG. 17(i), at the stage in FIG. 17(e), in which the rotation has been completed, the movable top part 53c is inclined forward toward one limit of its movable range. This change is caused according to gravity after the contact of the top part 53c with the projection 34c has been removed.

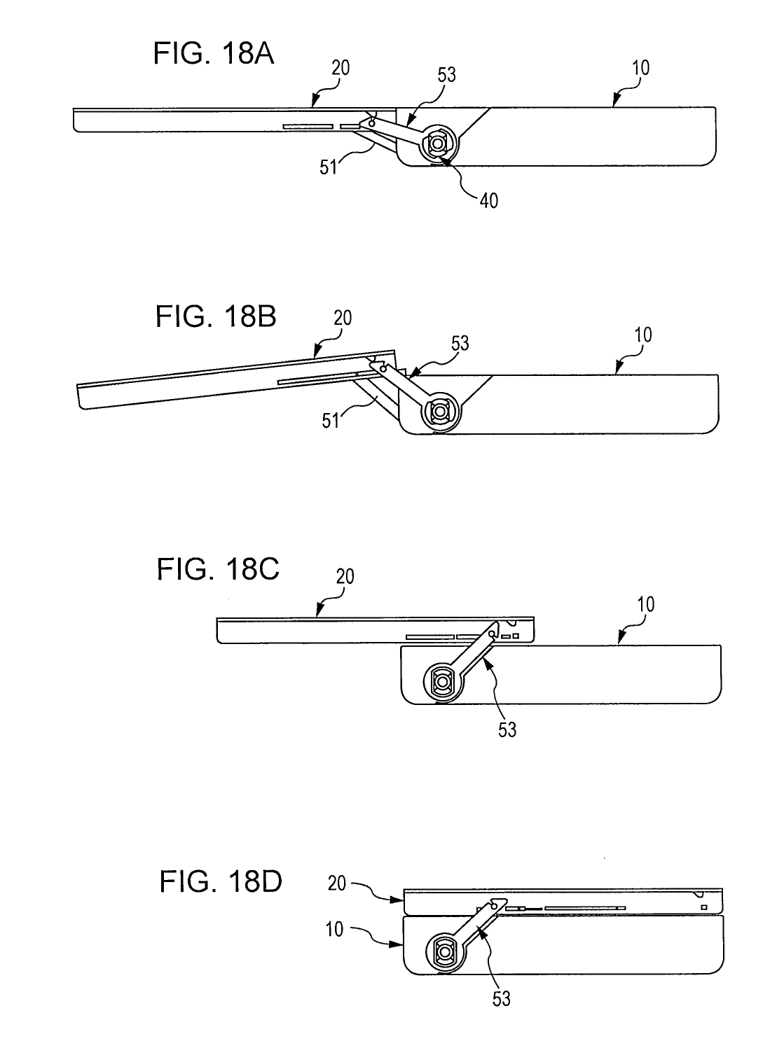

FIG. 18 illustrates processes taken when the mobile terminal in FIG. 17 shifts from the open state to the closed state. FIGS. 18(a) to 18(d) are general side views of the mobile terminal at stages during the shift of the mobile terminal from the open state to the closed state. FIGS. 18(e) and 18(f) are enlarged views of the major parts in FIGS. 18(a) and 18(b), respectively.

The operations of the mobile terminal illustrated in FIGS. 18(a) to 18(c) are operations in processes carried out by the user to lift the second case 20 from the first case 10 against the elastic force of the elastic member 36e and the biased force of the rotational hinge 40 and returns the second case 20 to the rotation start point (first stable state) of the rotational hinge 40. In this case, since the top part 53c operable as the extruding part is inclined downwardly, it is possible to prevent the top part 53c from interfering with the projection 34c of the support plate 32 during these processes as illustrated in FIG. 18(f). If the top part 53b is formed as part of the arm member 53, the top part 53b may interfere with the projection 34c of the support plate 32 in these processes, as illustrated for reference purposes in FIG. 18(g). To avoid this interference, the user must pull the second case 20 forward or upward more than necessary against the elastic force of the elastic member 36e or must take another extra manipulation. This variation eliminates this extra manipulation. FIG. 18(h) illustrates a state in which, due to the elastic force of the elastic member 36e, the support plate 32 is returning from the state in FIG. 18(f) to the second stable state illustrated in FIG. 9(b) with respect to the movable plate 36.

FIG. 18(c) illustrates a stage corresponding to the first stable state of the rotational hinge 40 and the second stable state of the slide hinge 30. If, in this state, the user slides the second case 20 backward against the biased force of the slide hinge 30 with respect to the first case 10, when the amount of slide exceeds the dead point, the direction of the biased force is inverted and the second case 20 automatically returns to the closed state of the mobile terminal illustrated in FIG. 18(d).

Next, the second embodiment will be described. The structure in the second embodiment is basically the same as the structure in the first embodiment, so only different points will be described.

In the second embodiment, to shift from the closed state of the mobile terminal to the open state, the slide operation of the slide hinge 30 is used as a trigger for rotating the rotational hinge 40 in the second stable state of the slide hinge 30. A structure and operation for this will be described below.

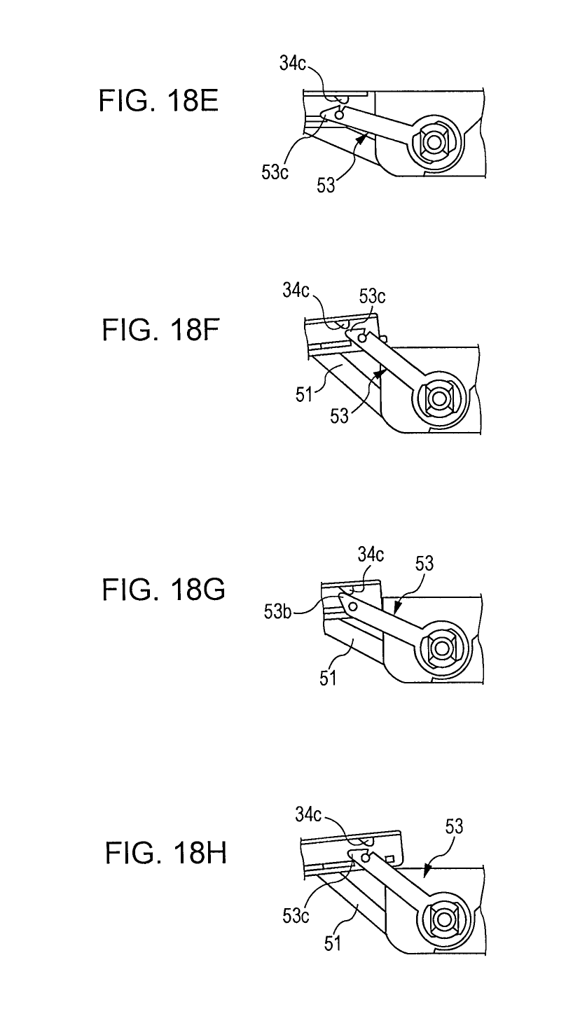

FIG. 19(a) illustrates a structure in which the movable part 36, arm members 51 and 53, and rotational hinge 40 in the second embodiment are mutually connected. This structure is basically the same as the structure illustrated in FIG. 6 in the first embodiment, except that an unlocking member 57 is provided for the arm member 53.

In this embodiment, the unlocking member 57 is formed with a bar member having a Y-shaped bottom. As well illustrated in FIG. 19(b), the bar of the unlocking member 57 is slidably fitted to the arm member 53 along grooves formed in the longitudinal direction of a side of the arm member 53. When the projection 34c (FIG. 5) formed on the support plate 32 comes into contact with the slide hinge 30 at a position immediately before the slide hinge 30 reaches its second stable state, the unlocking member 57 transmits, to the rotational hinge 40, a force with which its lock is released. In this sense, the projection 34c functions as a rotation actuating part that is an element for controlling the linkage between the slide operation and rotational operation of the complex hinge module 15. Instead of this, the rotation actuating part may be provided separately from the projection 34c.

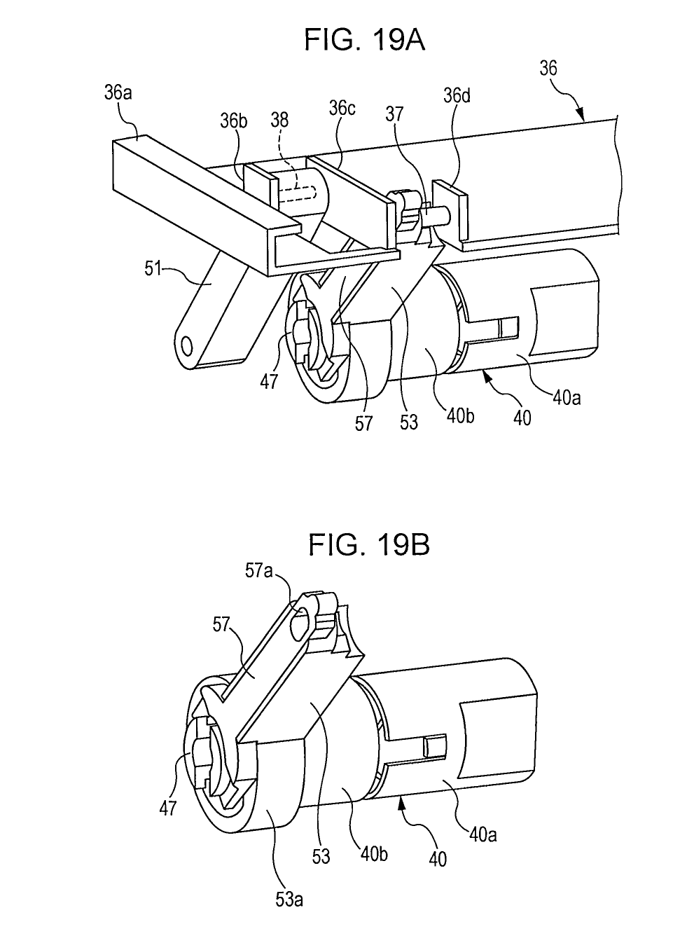

FIG. 20 illustrates a structure in the second embodiment in which the arm member 53 to which the unlocking member 57 is attached is linked to the rotational hinge 40. This drawing is a gray-scale image with the interior of the rotational hinge 40 visualized. A through-hole 57a is formed at the upper end of the unlocking member 57. The support shaft 37 passes through the through-hole 57a and the through-hole in the arm member 53. Since the through-hole 57a in the unlocking member 57 is an elliptical hole prolonged in the longitudinal direction, however, even in a state in which the support shaft 37 passes through the through-hole 57a, the unlocking member 57 can slide in the longitudinal direction of the through-hole 57a.

In FIG. 20, the upper end, of the arm member 53, that does not have a cutout appears. Although this example illustrates the top part 53b formed as part of the arm member 53, the movable top part 53c may be used as in the variation described above.

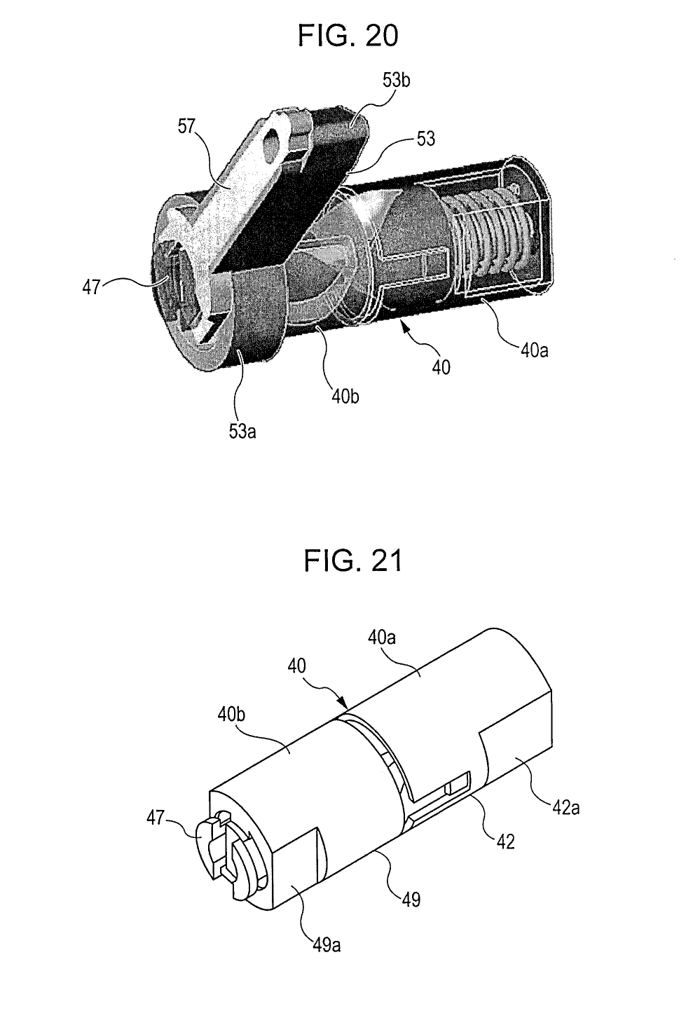

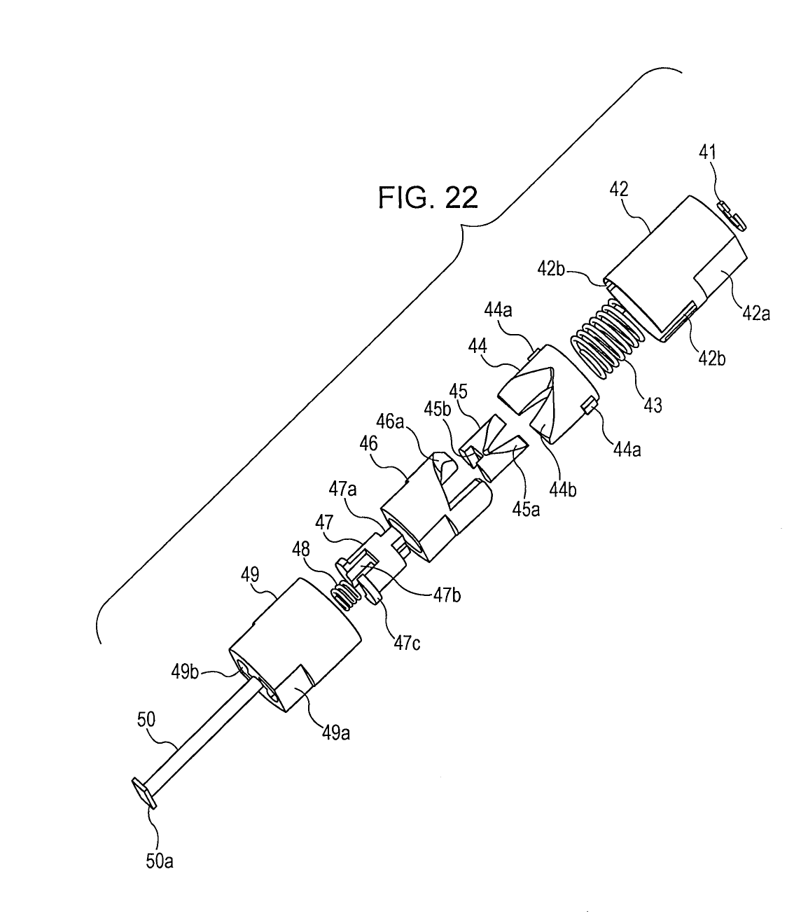

FIG. 21 a perspective view illustrating the appearance of the rotational hinge 40. The rotational hinge 40 includes the fixed part 40a and rotational part 40b, which are adjacently supported on the same shaft (50 in FIG. 22) and also includes a locking member 47, which locks the rotation of the rotational part 40b at a prescribed rotational angle with respect to the fixed part 40a. The rotational part 40b is rotatable on an axis common to the fixed part 40a and rotational part 40b.

The fixed part 40a has a fixed housing 42 in a substantially cylindrical outer shape. The fixed housing 42 has cutouts 42a, which make its cross section non-circular, at two opposite positions at an end on its circumference.

The rotational part 40b has a movable housing 49 in a substantially cylindrical outer shape. Similarly, the movable housing 49 has cutouts 49a, which make its cross section non-circular, at two opposite positions at an end on its circumference. When the rotational part 40b is positioned at the prescribed rotational angle with respect to the fixed part 40a against the biased force of the internal spring or the like, the lock function of the locking member 47 works. The rotation of the rotational part 40b with respect to the fixed part 40a is locked by the lock function. The internal constituent parts of the rotational hinge 40 will be described later.

When a prescribed external force is exerted on the locking member 47 with the lock function of the rotational hinge 40 enabled (in this embodiment, the locking member 47 is pulled toward the outside along the rotational axis), the lock is released. When the lock is released, the rotational part 40b automatically rotates by a prescribed angle with respect to the fixed part 40a.

FIG. 22 is an exploded perspective view of the parts constituting the rotational hinge 40. The rotational hinge 40 includes a fastener 41, the fixed housing 42, a spring member 43, a sliding cam 44, a rotor 45, a rotational cam 46, the locking member 47, a spring member 48, the movable housing 49, and a shaft 50. All parts other than the spring members 43 and 48 and the fastener 41 are made of rigid materials.

The shaft 50 passes through all other constituent components of the rotational hinge 40 and is engaged with the fastener 41 at its distal end. Examples of the fastener 41 are an E-ring and a C-ring. A flange 50a is provided at the proximal end of the shaft 50, the flange 50a being shaped so as to have cutouts on two sides.

The fixed housing 42 incorporates the spring member 43 and sliding cam 44 in its substantially cylindrical hollow with a bottom.

The sliding cam 44, which is part of the fixed part 40a, is slidable on the shaft 50 and is biased by an elastic force exerted in the first direction along the shaft 50. More specifically, the sliding cam 44 has a projection 44a on its outer circumference and, in the fixed housing 42, the projection 44a is supported so as to be slidable in the axial direction along a guide groove 42b formed on a side of the fixed housing 42. The sliding cam 44 is incorporated in the fixed housing 42 with the spring member 43 being compressed. The sliding cam 44 is biased by the spring member 43 toward the movable housing 49. The sliding cam 44 has cam surfaces 44b having an uneven shape on the same side as the movable housing 49.

The rotational cam 46, which is part of the rotational part 40b, is rotatably supported on the shaft 50 with the shaft 50 being used as an axis. The rotational cam 46 also functions so that it comes into contact with the sliding cam 44 and rotates as the sliding cam 44 slides. Accordingly, the rotational cam 46 is disposed on the shaft 50 with a cam surface 46a facing the cam surfaces 44b of the sliding cam 44. The rotational cam 46 has a substantially cylindrical hollow, in which the rotor 45 is incorporated.

In the rotational cam 46, the rotor 45 is rotatably supported on the shaft 50 with the shaft 50 being used as an axis. The rotor 45 functions so as to hold the sliding cam 44 in the first stable state at a prescribed angle with respect to the sliding cam 44 in cooperation with the rotational cam 46. Accordingly, the rotor 45 has cam surfaces 45a, having an uneven shape, which face the sliding cam 44. The rotor 45 also has a substantially linear engaging groove 45b at an end opposite to the cam surfaces 45a.

The locking member 47, which is slidable on the shaft 50, functions so that it is biased by an elastic force toward the sliding cam 44 and locks the rotation of the rotational cam 46 and rotor 45 at a prescribed relative rotational angle. Accordingly, the locking member 47 has a ridge 47a at its end and is slidably inserted into the hollow of the rotational cam 46 from a side, of the rotational cam 46, that is opposite to the rotor 45. The ridge 47a is removably engaged with the engaging groove 45b of the rotor 45 in the hollow of the rotational cam 46. The locking member 47 passes through an engaging hole (not shown), in the rotational cam 46, corresponding to the ridge 47a and reaches the rotor 45. Therefore, the locking member 47 does not rotate with respect to the rotational cam 46. With the ridge 47a of the locking member 47 disengaged from the engaging groove 45b, the rotor 45 is freely rotatable in the rotational cam 46.

The locking member 47 has a flange 47c, which is divided into two parts along a cut groove 47b formed in the locking member 47 in a diameter direction, at the end at which the cut groove 47b is formed. The locking member 47 is incorporated into a substantially cylindrical hollow, with a bottom, of the movable housing 49 through the spring member 48. The two-part flange 47c passes through an opening 49b formed in the movable housing 49 and outwardly protrudes of the end of the movable housing 49. The locking member 47 is supported so as to be slidable in the axial direction within a prescribed range in the movable housing 49. In this case, the compressed spring member 48 is located between the bottom of the hollow of the movable housing 49 and the bottom of the hollow of the locking member 47. Accordingly, the locking member 47 is biased by the spring member 48 toward the rotational cam 46.

The structure and operation of the rotational hinge 40 of this type may be the same as those of the rotational hinge 40 in the first embodiment.

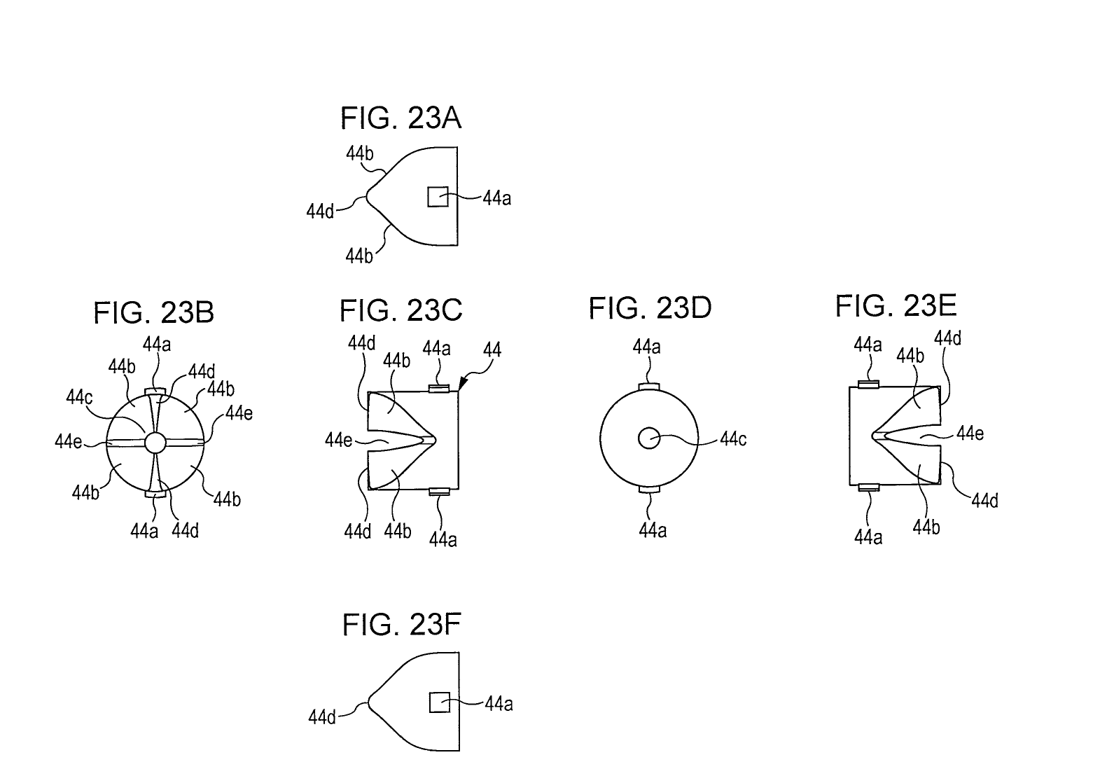

FIGS. 23, 24, and 25 are six-plane views, which respectively illustrate the appearances of the sliding cam 44, rotor 45, and rotational cam 46. In these drawings, (c) is a front view, (a) is a plan view, (f) is a bottom view, (b) is a left side view, (d) is a right side view, and (e) is a rear view.

The individual portions of the sliding cam 44 in FIG. 23 have been already described with reference to FIG. 22. In FIGS. 23(b) and 23(d), a through-hole 44c, through which the shaft 50 passes, is clearly illustrated. The sliding cam 44 has the cam surfaces 44b, which are specific.

Specifically, as well illustrated in the left-side view in FIG. 23(b), the sliding cam 44 has the cam surfaces 44b, each of which is located between one top part 44d formed along a diameter direction on a cylindrical cross section and a trench 44e formed along a diameter direction perpendicular to the top part 44d.

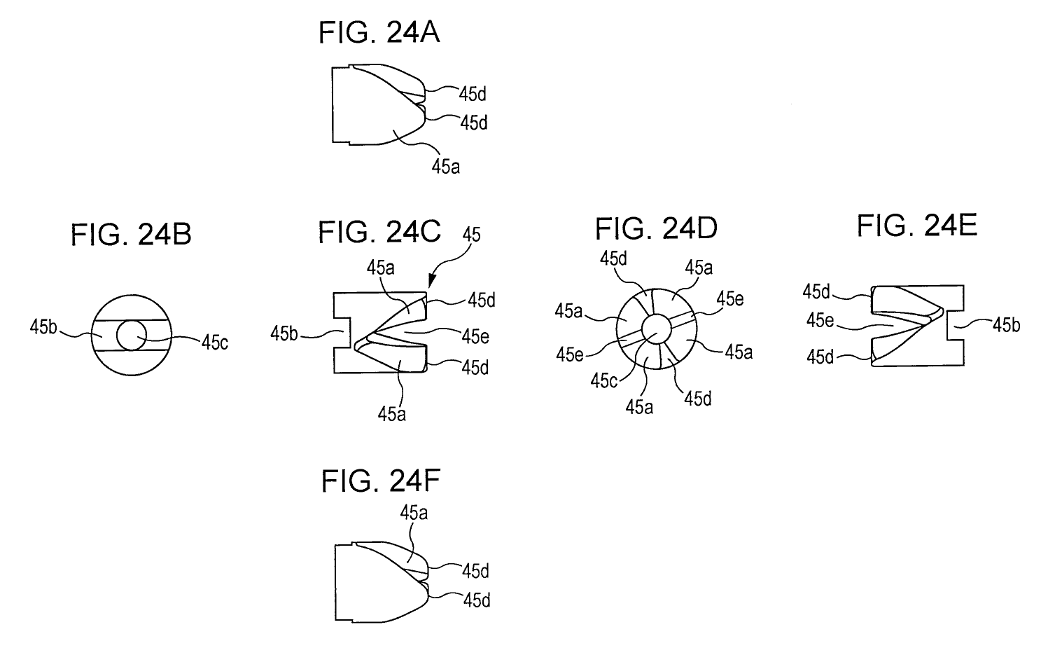

The individual portions of the rotor 45 in FIG. 24 have been already described with reference to FIG. 22. In FIGS. 24(b) and 24(d), a through-hole 45c, through which the shaft 50 passes, is clearly illustrated. As well illustrated in FIG. 24(d), the rotor 45 has the curved cam surfaces 45a, each of which is located between one top part 45d along a diameter direction on a cylindrical cross section and a trench 45e formed along a diameter direction perpendicular to the top part 45d.

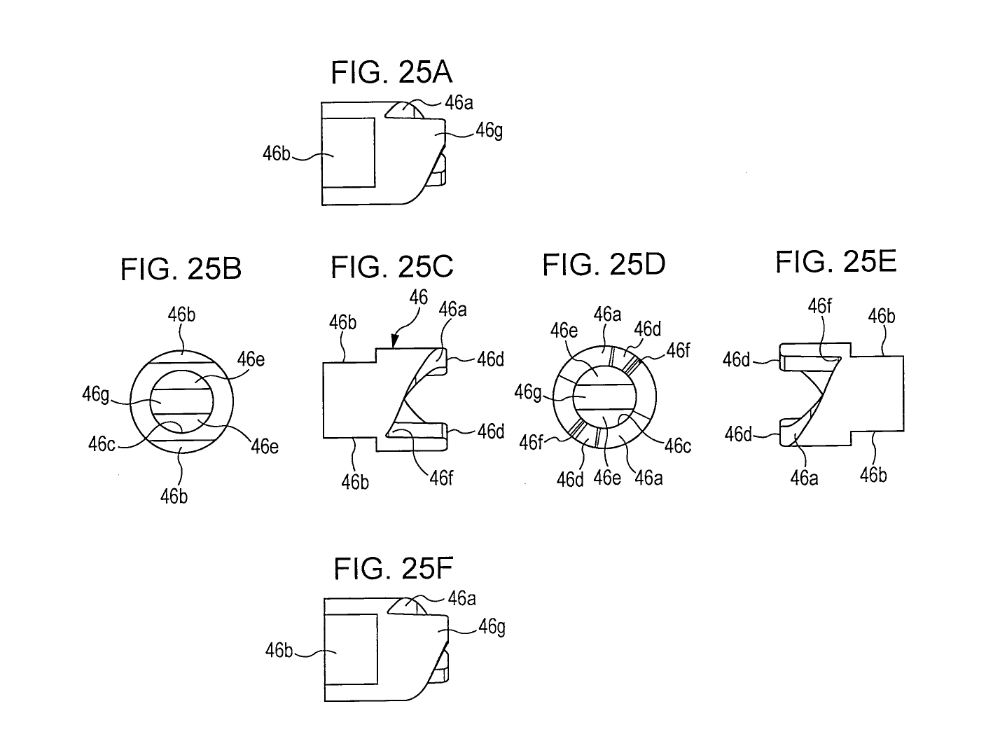

The individual portions of the rotational cam 46 in FIG. 25 have been already described with reference to FIG. 22. In FIGS. 25(b) and 25(d), a slit-like through-hole 46g is clearly illustrated with a cylindrical hollow 46c in the rotational cam 46 and a pair of inner walls 46e that narrow the hollow 46c at an intermediate portion in the hollow 46c, the ridge 47a of the locking member 47 slidably passing through the through-hole 46g. As well illustrated in FIG. 25(d), top parts 46d are provided along a diameter direction on a cylindrical cross section and bottom parts 46f are also provided, each of which is adjacent to one top part 46d. The curved cam surface 46a is formed, which is gradually lowered from one top part 46d to the bottom part 46f adjacent to the opposing top part 46d. Opposing cutouts 46b are formed on the circumference at an end opposite to the cam surface 46a of the rotational cam 46, making the cross section at the end non-circular.

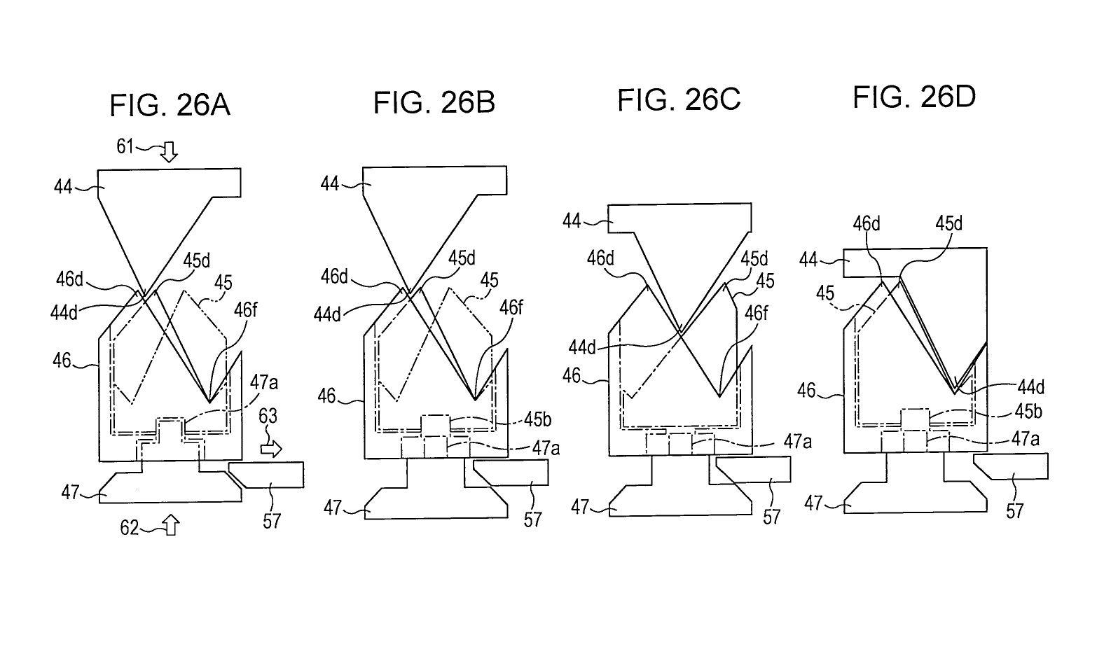

Processes of a shift from the first stable state of the rotational hinge 40, corresponding to the locked state, to the second stable state of the rotational hinge 40, which is brought after the lock has been released, will be described with reference to FIG. 26.

The locked state illustrated in FIG. 26(a) is the first stable state of the rotational hinge 40; this state is maintained unless any external force is exerted. In this state, the rotation of the rotor 45 with respect to the rotational cam 46 is locked by the locking member 47 and the rotation of the rotational part 40b with respect to the fixed part 40a is locked. Specifically, each top part 44d of the sliding cam 44 is positioned in the trench (concave part) formed between the top part 45d of the rotor 45 and the top part 46d of the rotational cam 46. In this state, even if an external force with which the rotational hinge 40 is rotated toward the second stable state is exerted, if the external force is not large enough to cause the top parts 44d of the cam surfaces 44b of the sliding cam 44 to move over the top parts 45d of the rotor 45, the external force is canceled by the rotational force generated by cam engagement according to a biased force 61. In other words, even if an external force is exerted in a direction in which the second case 20 (upper case) in the closed state with respect to the first case 10 (lower case) is opened, the external force is cancelled. Thus, in the first stable state of the rotational hinge 40, drawing torque with which the second case 20 is brought to the first case 10 due to the effect of the rotational hinge 40 is generated. As a result, backlash in the closed state, that is, backlash of the second case 20 with respect to the first case 10 in the first stable state is prevented.

The effect of the rotational hinge 40 of this type in this embodiment is obtained from a structure described below. That is, a direct biased force that causes rotation in the rotational direction is not exerted on the rotational cam 46 and any other parts of the rotational hinge 40, and the rotational force is generated by the effect of the sliding cam 44 and the rotational cam 46 according to the biased force in the axial direction.

If, in the first stable state of the rotational hinge 40, the unlocking member 57 functions for the inner wall of the flange 47c of the locking member 47 according to the external force, the locking member 47 is outwardly drawn against a biased force 62. In practice, as illustrated in FIG. 26(b), the Y-shaped end of the unlocking member 57 enters the space between the flange 47c of the locking member 47 and the arm member 53 so as to interrupt by a distance equivalent to an amount by which the unlocking member 57 has been extruded by the extruding part in the longitudinal direction of the arm member 53.

When the locking member 47 is outwardly drawn as illustrated in FIG. 26(b), the rotation of the rotor 45 (by extension, the rotational cam 46) is unlocked as described above. Then, the sliding cam 44 moves inwardly along the inclination of the cam surface 46a of the rotational cam 46 according to the biased force 61, as illustrated in FIG. 26(c). In the drawing, the sliding cam 44 is rotated with respect to the rotational cam 46 for the sake of convenience.

After that, the top parts 46d of the rotational cam 46 move until they reach the deepest bottom parts 46f of the cam shape of the rotational cam 46, as illustrated in FIG. 26(d). In this example, the amount of rotation of the rotational cam 46 with respect to the sliding cam 44 from the state in FIG. 26(a) to the state in FIG. 26(c) is about 130 degrees. In this case, the rotor 45 rotates through about 180 degrees from the state in FIG. 26(a). The state in FIG. 26(c) is equivalent to the second stable state of the rotational hinge 40.

When the external force exerted on the unlocking member 57 is eliminated, the unlocking member 57 is moved back to the original position by the elastic force. The locking member 47 is thereby pushed inwardly again by the biased force 62. At that time, since the rotor 45 is located at a position equivalent to the rotational angle in the locked state (a position reached after a rotation of about 180 degrees), the locked state is entered again.

The rotational operation of the rotational hinge 40 actuated by the external force in FIG. 26(a) automatically proceeds to FIG. 26(d) in a continuous manner.

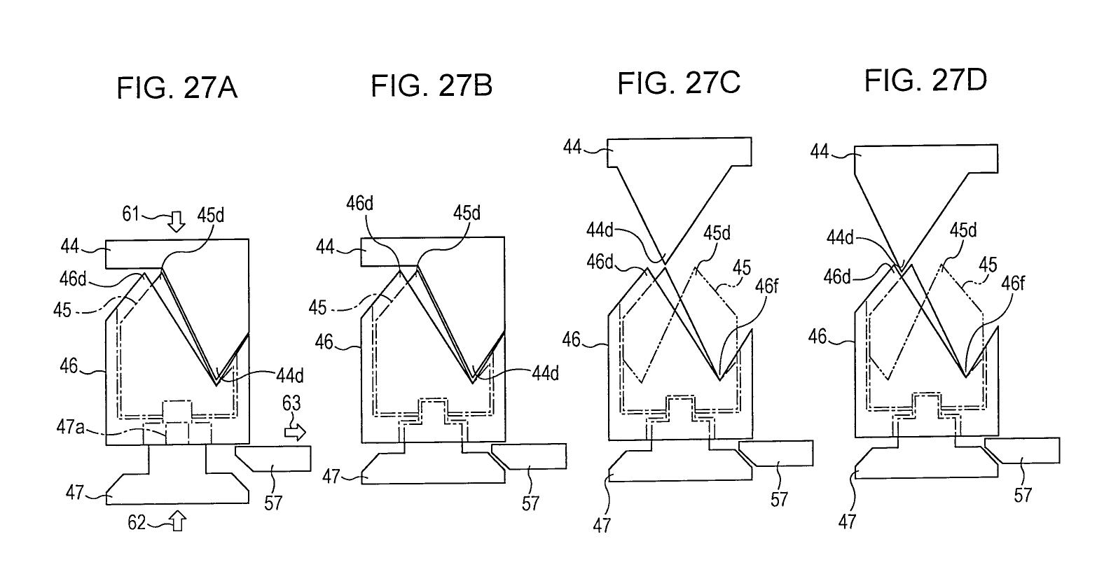

Next, processes of a shift from the second stable state of the rotational hinge 40 to the first stable state corresponding to the original locked state will be described with reference to FIG. 27.

FIG. 27(a) illustrates the state in FIG. 26(d). FIG. 27(b) illustrates a state in which the locking member 47 has returned to the original locked state. When, in this state, the rotational cam 46 is manually rotated clockwise against the biased force 61 as viewed from the locking member 47, the sliding cam 44 is retracted in the axial direction and its top parts 44d reach the top parts 45d of the rotor 45 as illustrated in FIG. 27(c). In the drawing as well, the sliding cam 44 is rotated for the sake of convenience. The biased force 61 is exerted as a force with which the rotational hinge 40 is returned to the second stable state until the top parts 44d of the sliding cam 44 reach the top parts 45d of the rotor 45. Furthermore, when the rotational cam 46 slightly rotates in the same direction, the top parts 44d of the sliding cam 44 move over the top parts 45d of the rotor 45 and drop into the trenches (concave parts) formed between the rotational cam 46 and the top parts 46d. This means that the rotational hinge 40 has returned to its first stable state. In this state, the biased force 61 is exerted as a force with which the rotational hinge 40 is kept in its first stable state against the external force.

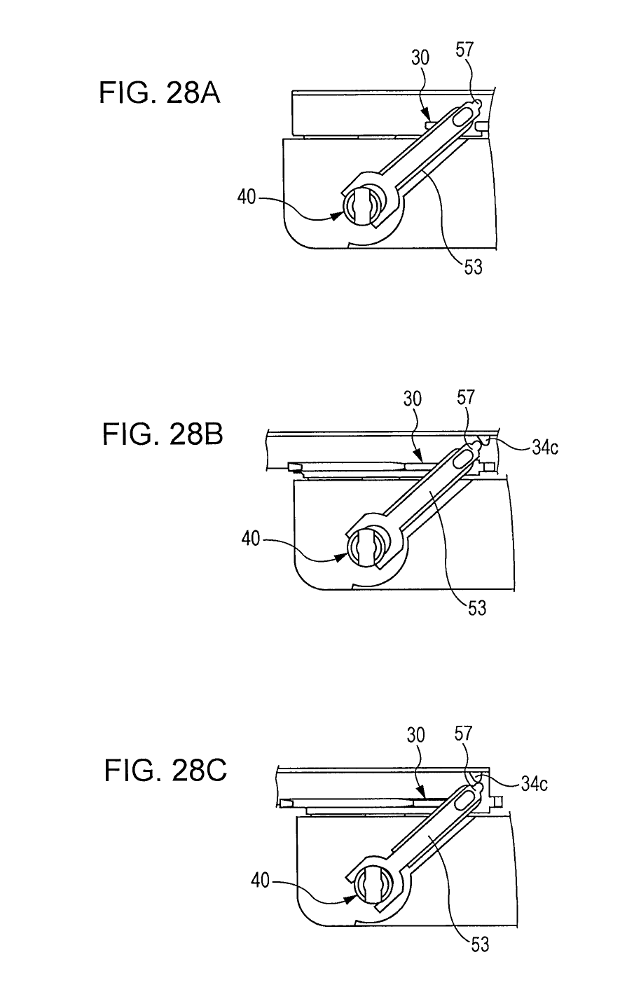

Smooth linkage between the slide operation of the slide hinge 30 and the rotational operation of the rotational hinge 40 when the mobile terminal according to this embodiment shifts from the open state to the closed state will be described with reference to FIG. 28. FIG. 28 gives schematic side views of the major parts of the mobile terminal. In this drawing, the first case 10 has a cutout at a position at which the arm member 53 in front of the rotational hinge 40 is visible, for the sake of convenience.

FIG. 28(a) illustrates the closed state of the mobile terminal. That is, both the slide hinge 30 and the rotational hinge 40 are in the first stable state. Suppose that, in this state, the second case 20 has slid upward (to the left in the drawing), with respect to the first case 10, due to a manipulation force of the user along the front surface of the first case 10. At that time, the second case 20 moves against the biased force of the spring members 39. When the movable plate 36 of the slide hinge 30 passes the dead point described above, the support plate 32 and, by extension, the second case 20 then automatically shift to the second stable state of the slide hinge 30 due to the biased force, the direction of which has been inverted.

As illustrated in FIG. 28(b), the projection 34c of the support plate 32 comes into contact with the end of the unlocking member 57 at a point immediately before the first case 10 reaches the end point of the slidable range. This causes the unlocking member 57 slides forward and down along the longitudinal direction of the arm member 53 as illustrated in FIG. 28(c). As a result, the Y-shaped end of the unlocking member 57 is pushed down and the locking member 47 is drawn outwardly, releasing the lock of the locking member 47 of the rotational hinge 40. This driving of the unlocking member 57 is used a trigger to shift the rotational hinge 40 from the first stable state to the second stable state as described above.

The arm member 53 and arm member 51 rotate through a prescribed angle around their rotational fulcrum on the first case 10 as the rotational hinge 40 rotates and shifts from the first stable state to the second stable state. Accordingly, the second case 20 shifts, with respect to the first case 10, from the state in FIG. 28(a) to the open state, in which the surface of the second case 20 is substantially flush with the surface of the first case 10.

Accordingly, when the user starts to slide the second case 20 and moves the second case 20 by a prescribed amount, the operation of the second case 20 then automatically proceeds through the remaining slide operation and the start of a rotational operation to the end of the rotation in a continuous manner.

Operations in the shift of the mobile terminal in the second embodiment from the open state to the closed state are the same as in the first embodiment, so repeated descriptions will be omitted.

The features in the second embodiment can be implemented in combination with the features in the first embodiment. In this case, the projection 34c used as the rotation actuating part in the second embodiment can double as the member in the first embodiment with which the extruding part comes into contact.

In an embodiment described above, a mobile terminal is described that has

a first case,

a second case, and

a complex hinge module that operates so as be shiftable between a closed state, in which the rear surface of the second case is overlaid on the front surface of the first case, and an open state, in which the front surface of the second case is placed next to the front surface of the first case so that the front surfaces become substantially flush with each other;

the complex hinge module has a slide hinge, a rotational hinge, and a link mechanism;

the slide hinge includes a movable plate and a support plate that linearly slidably supports the movable plate, the support plate being secured to the rear surface of the second case;

the rotational hinge includes a fixed part secured to the first case and a rotational part, which is rotatable on an axis common to the fixed part and the rotational part, and the rotational part is linked to the rotational plate through the link mechanism;

the slide hinge further includes an elastic member that moves the second case, by means of an elastic force, back to a position corresponding to a prescribed amount of slide enough for the second case to reach the open state if the second case slides more than the prescribed amount of slide;

the link mechanism has an extruding part that extrudes the support plate against the elastic force of the elastic member due to the rotation of the rotational hinge during the rotation, and when the second case slides beyond the prescribed amount of slide, the extruding part extrudes the support plate against the elastic force of the elastic member so that the back end of the second case bypasses the front end of the first case, the extruding part discontinuing the extrusion after the back end of the second case has bypassed the front end of the first case.

It is also described for a mobile terminal in which the extruding part is formed as a substantially triangular end, on the movable plate side, of an arm member constituting one link of the link mechanism, and the support plate has a projection with which the end of the arm member is brought into contact at the position corresponding to the prescribed amount of slide.

With the mobile terminal, it is also described that the arm member has a main body, and the substantially triangular end is rotatably supported with respect to the main body within a prescribed rotational angle range.

It is also described that the elastic member is provided at a prescribed position on one of the support plate and the movable plate, and a projection that is brought into contact with the elastic member at the position corresponding to the prescribed amount of slide is provided at a prescribed position on the other of the support plate and the movable plate.

It is also described for a mobile terminal in which the slide hinge further has an elastic member that biases the movable plate in a first direction toward one end of the support plate when the movable plate is placed at the one end with an intermediate position in the slide range of the movable plate being taken as a boundary, and also biases the movable plate in a second direction toward the other end when the movable plate is placed at the other end.

It is also described for a mobile terminal in which the rotational hinge further has an elastic member that provides a biased force with which the rotational part is rotated with respect to the fixed part and a locking member that locks the rotation of the rotational part at a predetermined angle with respect to the fixed part against the biased force in a state before the rotational hinge starts to rotate, and the support plate further has a rotation actuating member that unlocks the rotational hinge and actuates the rotation of the rotational part at a position while the movable plate shifts from a first stable state to a second stable state, the position being taken immediately before the movable plate reaches the second stable state.

Although preferred embodiments have been described, various variations and modifications can be made besides the above descriptions. That is, it will be understood by those skilled in the art that various modification and combinations and other embodiments may be derived from design or other elements within the range of the claims or an equivalent range of the claims.

For example, the mobile terminal may include mobile telephone terminals, mobile information terminals (including so-called smart phones), mobile game machines, mobile personal computers (PCs), digital cameras, electronic dictionaries, and any other terminals.

Although a spring has been used as an elastic member, this is not a limitation; any members generating an elastic force can be used.

Although the first case and the second case have been described for a mobile terminal having a display screen (display device) on the front surface of each of the first case and the second case, the two cases do not necessarily have to have a display screen. For example, one case may have another functional part such as a keyboard.

To mutually link the rotation of the slide hinge 30 and the operation of the rotational hinge 40, the unlocking member 57 has been used in the second embodiment as a member that transmits an unlocking force to release the lock of the rotational hinge 40. However, the specific shape and effect of this member are not necessarily limited to the above description.

### REFERENCE SIGNS LIST

10: first case (lower case)
12, 22: display screen
15: complex hinge module
20: second case (upper case)
22: display screen
30: slide hinge
32: support plate
32a: projection
34: slide guide
34a: concave groove
34b: side edge
34c: projection
35: flat-plate-like member
36: movable plate
36a: hook
36b to 36d: shaft support member
36e: elastic member
37, 38: support shaft
39: spring member
40: rotational hinge
40a: fixed part
40b: rotational part
41: fastener
42: fixed housing
42a: cutout
42b: guide groove
43: spring member
44: sliding cam
44a: projection
44b: cam surface
44c: through-hole
44d: top part
45: rotor
45a: cam surface
45b: engaging groove
45c: through-hole
45d: top part
45e: trench
46: rotational cam
46a: cam surface
46b: cutout
46c: hollow
46d: top part
46e: inner wall
46f: bottom part
46g: through-hole
47: locking member
47a: ridge
47b: cut groove
47c: flange
48: spring member
49: movable housing
49a: cutout
49b: opening
50: shaft
50a: flange
51, 53: arm member
53a: ring-shaped member
53b: top part
53c: movable top part
53d: through-hole
53e: main part
53f, 53g: through-hole
57: unlocking member (Y-shaped bar member)
57a: through-hole
61, 62: biased force
100: mobile terminal

What is claimed is:

1. A terminal apparatus comprising:
a first case;
a second case; and
a complex hinge module that has a slide hinge and a rotational hinge, to shift each of the first case and the second case between a closed state and an opened state,
wherein the slide hinge further includes a movable plate, a support plate that slidably supports the movable plate and is secured to the second case, and an elastic member configured to move the second case back toward the first case, and
wherein the rotational hinge includes a fixed part secured to the first case, a rotational part which is rotatable on an axis common to the fixed part and the rotational part, and a link mechanism that connects the rotational part with the movable plate and has an extruding part to move the second case.

2. The terminal apparatus according to claim 1, wherein the elastic member moves the second case, by means of an elastic force, back to a position corresponding to a prescribed amount of slide enough for the second case to reach the open state when the second case slides more than the prescribed amount of slide.

3. The terminal apparatus according to claim 2, wherein the extruding part is configured to extrude the support plate against the elastic force of the elastic member due to a rotation of the rotational hinge, and when the second case slides beyond the prescribed amount of slide, the extruding part extrudes the support plate against the elastic force of the elastic member so that the back end of the second case bypasses the front end of the first case, the extruding part discontinuing the extrusion after the back end of the second case has bypassed the front end of the first case.

4. The terminal apparatus according to claim 2, wherein the extruding part is formed on an arm member of the link mechanism, and the support plate has a projection with which the end of the arm member is brought into contact at the position corresponding to the prescribed amount of slide.

5. The terminal apparatus according to claim 4, wherein the arm member has a main body, and an end of the extruding part is rotatably supported with respect to the main body within a prescribed rotational angle range.

6. The terminal apparatus according to claim 1, wherein the elastic member is provided at a prescribed position on one of the support plate and the movable plate, and a projection that is brought into contact with the elastic member at the position corresponding to the prescribed amount of slide is provided at a prescribed position on the other of the support plate and the movable plate.

7. The terminal apparatus according to claim 1, wherein the slide hinge further has a spring member that biases the movable plate in a first direction toward one end of the support plate when the movable plate is placed at the one end with an intermediate position in the slide range of the movable plate being taken as a boundary, and also biases the movable plate in a second direction toward the other end when the movable plate is placed at the other end.

8. The terminal apparatus according to claim 1, wherein the rotational hinge further has a spring member that provides a biased force with which the rotational part is rotated with respect to the fixed part and a locking member that locks the rotation of the rotational part at a predetermined angle with respect to the fixed part against the biased force in a state before the rotational hinge starts to rotate.

9. The terminal apparatus according to claim 8, wherein the support plate further has a rotation actuating member that unlocks the rotational hinge and actuates the rotation of the rotational part at a position while the movable plate shifts from a first stable state to a second stable state, the position being taken immediately before the movable plate reaches the second stable state.

10. The terminal apparatus according to claim 1, wherein the extruding part is formed as a substantially triangular end, on the movable plate side, of an arm member constituting one link of the link mechanism.

11. The terminal apparatus according to claim 1, wherein the first case and the second case each comprise a display screen on a front surface thereof, such that when the terminal apparatus is in the closed state, the display screen on the second case is visible but the display screen on the first case is not visible, and when the terminal apparatus is in the open state, both of the display screens of the first case and the second case are visible and adjacent to each other.

12. The terminal apparatus according to claim 11, wherein when the terminal apparatus is in the open state the display screens of the first case and the second case are combined to act as a single display screen.
